(19) United States
(12) Patent Application Publication
(10) Pub. No.: US 2025/0117879 A1
(43) Pub. Date: Apr. 10, 2025

(54) INFORMATION PROCESSING APPARATUS, INFORMATION PROCESSING METHOD, AND INFORMATION PROCESSING PROGRAM

(71) Applicant: FUJIFILM Corporation, Tokyo (JP)

(72) Inventors: Tetsuya FUJIKAWA, Saitama-shi (JP); Masahiko SUGIMOTO, Saitama-shi (JP); Tomoharu SHIMADA, Saitama-shi (JP)

(73) Assignee: FUJIFILM Corporation, Tokyo (JP)

(21) Appl. No.: 18/985,042

(22) Filed: Dec. 18, 2024

Related U.S. Application Data
(63) Continuation of application No. PCT/JP2023/020785, filed on Jun. 5, 2023.

(30) Foreign Application Priority Data
Jun. 27, 2022 (JP) 2022-102804

(51) Int. Cl. G06T 3/40; G06F 3/14; G06T 3/60; G06T 5/50

(52) U.S. Cl. CPC G06T 3/40; G06F 3/14; G06T 3/60; G06T 5/50; G06T 2207/20221

(57) ABSTRACT

An information processing apparatus includes: a processor; and the processor is configured to determine an imaging method for imaging a designated imaging target region a plurality of times according to a form of the imaging target region, acquire a plurality of pieces of first image data obtained by imaging in the imaging method, and generate second image data related to the imaging target region by performing, onto the plurality of pieces of first image data, resize processing in a reduction direction and combining processing.

### CROSS REFERENCE TO RELATED APPLICATION

This is a continuation of International Application No. PCT/JP2023/020785 filed on Jun. 5, 2023, and claims priority from Japanese Patent Application No. 2022-102804 filed on Jun. 27, 2022, the entire disclosures of which are incorporated herein by reference.

### BACKGROUND OF THE INVENTION

### 1. Field of the Invention

The present invention relates to an information processing apparatus, an information processing method, and a computer readable medium storing an information processing program.

### 2. Description of the Related Art

JP2004-194113A discloses an image signal processing apparatus that generates an image signal by sequentially changing an imaging direction to image an imaging range such that overlapping image regions are generated, and records a unit image based on the generated image signal on a storage medium by associating the unit image with other unit images forming the overlapping image regions. WO2020-162264A discloses an imaging location setting apparatus that acquires an image of an imaging target and displays the image on a display unit, generates information indicating a location of a designated imaging location in the captured image, and cuts out an image including a periphery of the imaging location from the image of the imaging target to generate a reference image. JP2017-011687A discloses an image processing apparatus that acquires a plurality of captured images with different angles, reduces the acquired plurality of captured images, combines the reduced plurality of captured images to generate a preview image, and displays the preview image on a part of a display unit that displays the captured image.

### SUMMARY OF THE INVENTION

One embodiment according to the technique of the present disclosure provides an information processing apparatus, an information processing method, and a computer readable medium storing an information processing program capable of reducing the strain on a computing resource.

(1)

An information processing apparatus comprising:

a processor;

in which the processor is configured to
determine an imaging method for imaging a designated imaging target region a plurality of times according to a form of the imaging target region,
acquire a plurality of pieces of first image data obtained by imaging in the imaging method, and
generate second image data related to the imaging target region by performing resize processing in a reduction direction and combining processing on the plurality of pieces of first image data.
   (2)

The information processing apparatus according to (1),

in which the processor is configured to receive designation for a form other than a rectangular form as the form of the imaging target region.

(3)

The information processing apparatus according to (2),

in which the processor is configured to, in a case where the designation of the form other than the rectangular form is received as the form of the imaging target region, generate the second image data representing a rectangular image.

(4)

The information processing apparatus according to any one of (1) to (3),

in which the imaging method includes acquiring an imaging angle of view and an imaging position in the imaging.

(5)

The information processing apparatus according to any one of (1) to (4),

in which the processor is configured to generate first correspondence information that associates a relationship between a first image represented by the first image data and a position of the first image in a second image represented by the second image data.

(6)

The information processing apparatus according to (5),

in which the processor is configured to perform control to display, on a display device, the first image represented by the first image data corresponding to designated coordinates in the second image data based on the first correspondence information.

(7)

The information processing apparatus according to any one of (1) to (6),

in which the resize processing is resize processing including a geometric change.

(8)

The information processing apparatus according to (7),

in which the resize processing including the geometric change is processing of generating the second image data by the resize processing in the reduction direction, geometric processing of giving a geometric change different from reduction and enlargement to the first image data, and the combining processing, based on the first image data.

(9)

The information processing apparatus according to (8),

in which the processor is configured to perform processing in an order of the geometric processing, the resize processing in the reduction direction, and the combining processing.

(10)

The information processing apparatus according to (8) or (9),

in which the geometric processing includes rotation processing

(11)

The information processing apparatus according to (10),

in which the rotation processing includes processing based on an imaging condition under which the first image data is obtained.

(12)

The information processing apparatus according to (10),

in which the rotation processing includes processing of calculating a parameter for correcting an inclination of an angle of view during telephoto imaging.

(13)

The information processing apparatus according to any one of (1) to (12),

in which the processor is configured to acquire a reduction rate in the resize processing in the reduction direction based on a size of a second image represented by the second image data.

(14)

The information processing apparatus according to any one of (1) to (13),

in which the processor is configured to
control a revolution mechanism that causes an imaging apparatus performing the imaging to revolve, and
generate second correspondence information in which the first image data and a control value of the revolution mechanism at a time of imaging at which the first image data is obtained are associated with each other.
   (15)

The information processing apparatus according to (14),

in which the processor is configured to output a control value corresponding to designated first image data among the plurality of pieces of first image data based on the second correspondence information.

(16)

The information processing apparatus according to (14) or (15),

in which the processor is configured to extract the first image data based on a degree of approximation of a designated control value from among the plurality of pieces of first image data based on the second correspondence information.

(17)

The information processing apparatus according to any one of (1) to (16),

in which the processor is configured to, after acquiring distance measurement information of a plurality of positions in the imaging target region with a smaller number of times of imaging than the number of times of imaging in the imaging method, perform control of causing the imaging apparatus to execute the imaging by means of the imaging method based on the distance measurement information.

(18)

An information processing method executed by an information processing apparatus, the method comprising:

via a processor of the information processing apparatus,
determining an imaging method for imaging a designated imaging target region a plurality of times according to a form of the imaging target region;
acquiring a plurality of pieces of first image data obtained by imaging in the imaging method; and
generating second image data related to the imaging target region by performing resize processing in a reduction direction and combining processing on the plurality of pieces of first image data.
   (19)

An information processing program, stored in a computer readable medium, for an information processing apparatus, the program causing a processor of the information processing apparatus to execute a process comprising:
determining an imaging method for imaging a designated imaging target region a plurality of times according to a form of the imaging target region;
acquiring a plurality of pieces of first image data obtained by imaging in the imaging method; and
generating second image data related to the imaging target region by performing resize processing in a reduction direction and combining processing on the plurality of pieces of first image data.

According to the present invention, it is possible to provide an information processing apparatus, an information processing method, and a computer readable medium storing an information processing program capable of reducing the strain on the computing resource.

### BRIEF DESCRIPTION OF THE DRAWINGS

FIG. 1 is a diagram showing an example of an imaging system 1 equipped with an information processing apparatus (management apparatus 11) according to the present embodiment.

FIG. 2 is a diagram showing an example of revolution of a camera 10 in a pitch direction by a revolution mechanism 16.

FIG. 3 is a diagram showing an example of the revolution of the camera 10 in a yaw direction by the revolution mechanism 16.

FIG. 4 is a block diagram showing an example of configurations of an optical system and an electrical system of the camera 10.

FIG. 5 is a diagram showing an example of a configuration of an electrical system of the revolution mechanism 16 and a management apparatus 11.

FIG. 6 is a flowchart showing an example of imaging processing of an imaging target region and combining processing of a composite image by a CPU 60A of the management apparatus 11.

FIG. 7 is a diagram showing an example of designation of an imaging target region 92 in a wide angle image 91.

FIG. 8 is a diagram showing an example in which a plurality of imaging regions rn captured by the camera 10 are set for the imaging target region 92.

FIG. 9 is a diagram showing an example in which a plurality of imaging regions rn are subjected to telephoto imaging by the camera 10.

FIG. 10 is a diagram showing detailed partial images 93a to 93c and minified images 94a to 94c generated based on the detailed partial images 93a to 93c.

FIG. 11 is a diagram showing a composite image 95 generated by the minified image 94n.

FIG. 12 is coordinate correspondence information 97 showing a correspondence relationship between the captured image data of the detailed partial image 93n and coordinates of the detailed partial image 93n on the composite image 95.

FIG. 13 is a flowchart showing an example of a display processing of a composite image and a detailed partial image by the CPU 60A of the management apparatus 11.

FIG. 14 is a diagram showing an example of designation of an inspection location in a composite image 95 and a detailed partial image 93n displayed based on the designated position.

FIG. 15 is a diagram showing an example of inspecting an electric wire 102 of a transmission tower 101.

FIG. 16 is a diagram showing an example of inspecting a blade 112 of a windmill 111.

FIG. 17 is a diagram showing an example in which an imaging target region is designated by a point group.

FIG. 18 is a diagram showing an example in which an imaging target region is designated by a line.

FIG. 19 is a flowchart showing an example of imaging processing of an imaging target region and combining processing of a composite image in a case where the imaging target region is designated by a point group.

FIG. 20 is a diagram showing interpolation processing between imaging regions in a case where an imaging target region is designated by a point group.

FIG. 21 is a flowchart showing an example of display processing of a composite image and a detailed partial image in a case where an imaging target region is designated by a point group.

FIG. 22 is a diagram showing an example in which a subject close to designated coordinates is included in a plurality of imaging regions rn.

FIG. 23 is a diagram showing an example of imaging in a case where an imaging target of the camera 10 exceeds an imaging range at a wide angle end.

FIG. 24 is a diagram showing an example of a pseudo wide angle image 150 captured by the camera 10.

FIG. 25 is a diagram showing designation of an imaging target region in the pseudo wide angle image 150.

FIG. 26 is a diagram showing a modification example of the composite image 95 displayed on the display 13a in a case of designating the inspection location.

FIG. 27 is a diagram showing an example in which geometric processing is performed in a case of generating a composite image.

FIG. 28 is a diagram showing an example of an aspect in which the information processing program for management control is installed in the control device 60 of the management apparatus 11 from a storage medium in which the information processing program is stored.

### DESCRIPTION OF THE PREFERRED EMBODIMENTS

Hereinafter, an example of an embodiment of the present invention will be described with reference to the drawings.

### <Imaging System of Embodiment>

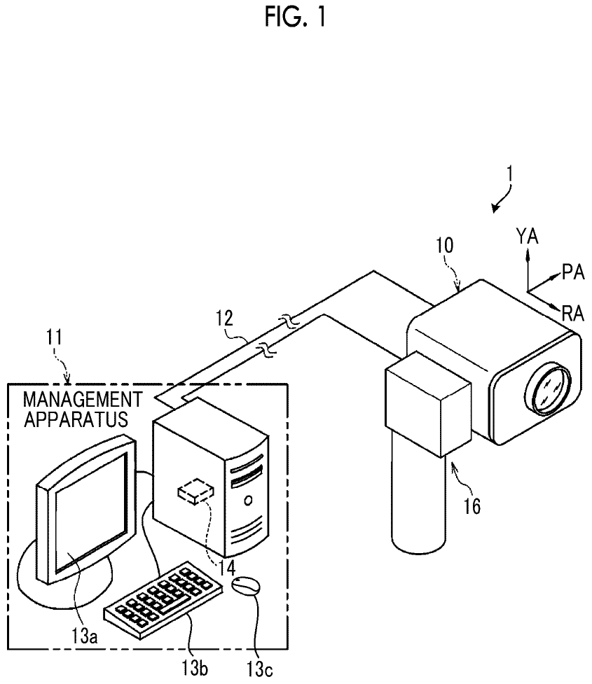

FIG. 1 is a diagram showing an example of an imaging system 1 equipped with an information processing apparatus according to the present embodiment. As an example, as shown in FIG. 1, an imaging system 1 includes a camera 10 and a management apparatus 11. The camera 10 is an example of an imaging apparatus according to the embodiment of the present invention. The management apparatus 11 is an example of an information processing apparatus according to the embodiment of the present invention.

The camera 10 is a camera for inspecting a facility (infrastructure) that is the basis of life and industrial activities. The camera 10 inspects, for example, a wall surface of a building, a power transmission line, a windmill, and the like. A camera capable of telephoto imaging, a camera having ultra-high resolution, and the like are used as the camera 10. In addition, a wide angle camera may be used as the camera 10. The camera 10 is installed via a revolution mechanism 16 described below, and images an imaging target, which is a subject. Further, the camera 10 transmits the captured image obtained by capturing and the imaging information related to the capturing of the captured image to the management apparatus 11 via the communication line 12.

The management apparatus 11 comprises a display 13a, a keyboard 13b, a mouse 13c, and a secondary storage device 14. Examples of the display 13a include a liquid crystal display, a plasma display, an organic electro-luminescence (EL) display, and a cathode ray tube (CRT) display. The display 13a is an example of a display device according to the embodiment of the present invention.

An example of the secondary storage device 14 includes a hard disk drive (HDD). The secondary storage device 14 is not limited to the HDD, and may be a non-volatile memory such as a flash memory, a solid state drive (SSD), or an electrically erasable and programmable read only memory (EEPROM).

The management apparatus 11 receives the captured image or the imaging information transmitted from the camera 10, and displays the received captured image or imaging information on the display 13a or stores the received captured image or imaging information in the secondary storage device 14.

The management apparatus 11 performs imaging control of controlling imaging performed by the camera 10. For example, the management apparatus 11 performs the imaging control by communicating with the camera 10 via the communication line 12. The imaging control is control of setting an imaging parameter for the camera 10 to perform imaging in the camera 10 and causing the camera 10 to perform the imaging. The imaging parameters include a parameter related to exposure, a parameter of a zoom position, and the like.

In addition, the management apparatus 11 controls the revolution mechanism 16 to control the imaging direction (pan or tilt) of the camera 10. For example, the management apparatus 11 sets the revolution direction, the revolution amount, the revolution speed, and the like of the camera 10 in response to an operation of the keyboard 13b and the mouse 13c, or a touch operation of the display 13a on the screen.

### <Revolution of Camera 10 by Revolution Mechanism 16>

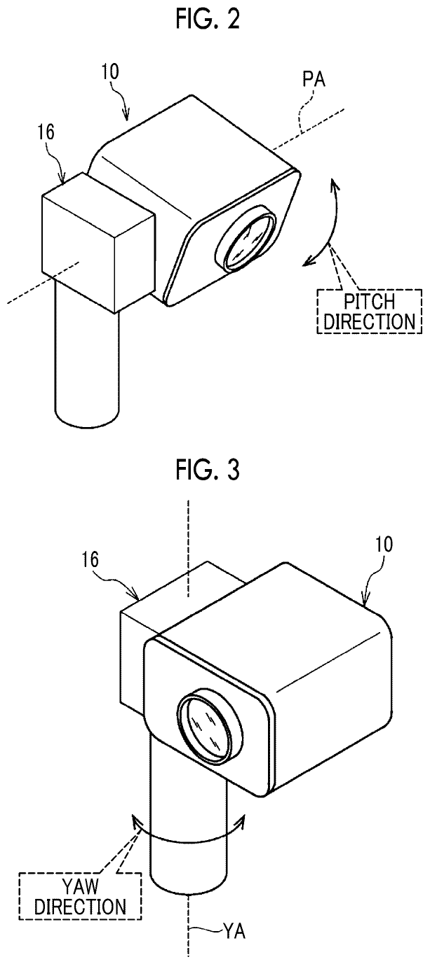

FIG. 2 is a diagram showing an example of revolution of the camera 10 in a pitch direction by the revolution mechanism 16. FIG. 3 is a diagram showing an example of revolution of the camera 10 in a yaw direction by the revolution mechanism 16. The camera 10 is attached to the revolution mechanism 16. The revolution mechanism 16 allows the camera 10 to revolve.

Specifically, the revolution mechanism 16 is a two-axis revolution mechanism that enables the camera 10 to revolve in a revolution direction (pitch direction) that intersects the yaw direction and that has a pitch axis PA as a central axis, as shown in FIG. 2 as an example, and in a revolution direction (yaw direction) that has a yaw axis YA as a central axis, as shown in FIG. 3 as an example. An example is shown in which the two-axis revolution mechanism is used as the revolution mechanism 16 according to the present embodiment; however the technique of the present disclosure is not limited thereto. A three-axis revolution mechanism or a one-axis revolution mechanism may be used.

### <Configuration of Optical System and Electrical System of Camera 10>

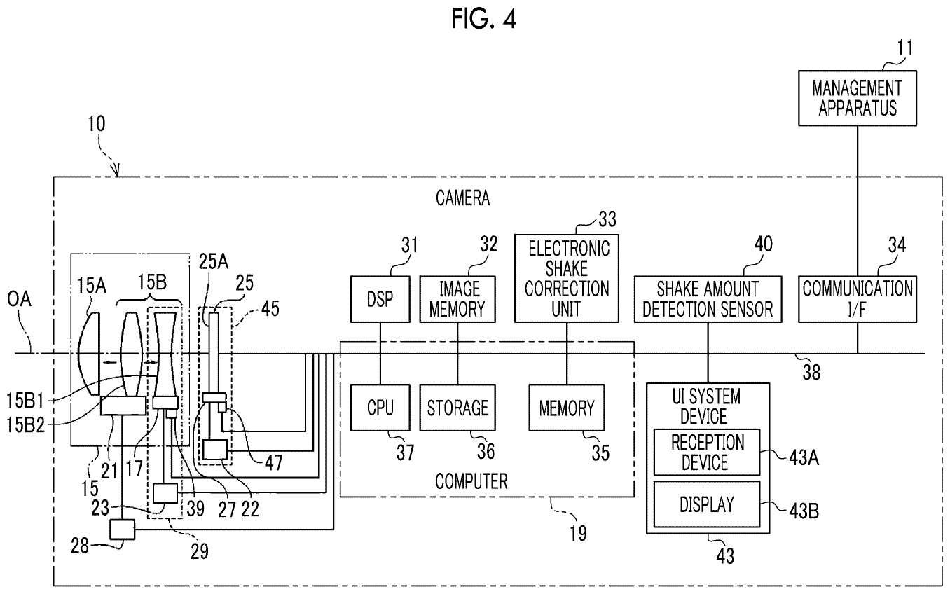

FIG. 4 is a block diagram showing an example of a configuration of an optical system and an electrical system of the camera 10. As shown in FIG. 4 as an example, the camera 10 comprises an optical system 15 and an imaging element 25. The imaging element 25 is located in a rear stage of the optical system 15. The optical system 15 comprises an objective lens 15A and a lens group 15B. The objective lens 15A and the lens group 15B are disposed, along an optical axis OA of the optical system 15, over a light-receiving surface 25A side (image side) of the imaging element 25 from a target subject side (object side) in an order of the objective lens 15A and the lens group 15B. The lens group 15B includes an anti-vibration lens 15B1, a focus lens (not shown), a zoom lens 15B2, and the like. The zoom lens 15B2 is movably supported along the optical axis OA by a lens actuator 21 described below. The anti-vibration lens 15B1 is movably supported in a direction orthogonal to the optical axis OA by a lens actuator 17 described below.

Since an increase in a focal length by the zoom lens 15B2 sets the camera 10 on a telephoto side, an angle of view decreases (imaging range is narrowed). Since a decrease in the focal length by the zoom lens 15B2 sets the camera 10 on a wide angle side, the angle of view increases (imaging range is widened).

Various lenses (not shown) may be provided as the optical system 15 in addition to the objective lens 15A and the lens group 15B. Furthermore, the optical system 15 may comprise a stop. Positions of the lenses, the lens group, and the stop included in the optical system 15 are not limited. For example, the technique of the present disclosure is also effective for positions different from the positions shown in FIG. 4.

The anti-vibration lens 15B1 is movable in a direction perpendicular to the optical axis OA, and the zoom lens 15B2 is movable along the optical axis OA.

The optical system 15 comprises the lens actuators 17 and 21. The lens actuator 17 causes a force that fluctuates in a direction perpendicular to an optical axis of the anti-vibration lens 15B 1 to act on the anti-vibration lens 15B1. The lens actuator 17 is controlled by an optical image stabilizer (OIS) driver 23. With the drive of the lens actuator 17 under the control of the OIS driver 23, the position of the anti-vibration lens 15B1 fluctuates in the direction perpendicular to the optical axis OA.

The lens actuator 21 causes force for moving along the optical axis OA of the optical system 15 to act on the zoom lens 15B2. The lens actuator 21 is controlled by a lens driver 28. With the drive of the lens actuator 21 under the control of the lens driver 28, the position of the zoom lens 15B2 moves along the optical axis OA. With the movement of the position of the zoom lens 15B2 along the optical axis OA, the focal length of the camera 10 changes.

For example, in a case where a contour of the captured image is a rectangle having a short side in the direction of the pitch axis PA and having a long side in the direction of the yaw axis YA, the angle of view in the direction of the pitch axis PA is narrower than the angle of view in the direction of the yaw axis YA and also narrower than the angle of view of a diagonal line.

With the optical system 15 configured as described above, the light indicating the imaging target region is imaged on the light-receiving surface 25A of the imaging element 25, and the imaging target region is imaged by the imaging element 25.

By the way, a vibration applied to the camera 10 includes, in an outdoor situation, a vibration caused by passage of automobiles, a vibration caused by wind, a vibration caused by a road construction, and the like, and includes, in an indoor situation, a vibration caused by an air conditioner operation, a vibration caused by comings and goings of people, and the like. Therefore, in the camera 10, shake occurs due to vibration (hereinafter, also simply referred to as “vibration”) applied to the camera 10.

In the present embodiment, the term “shake” refers to a phenomenon in which, in the camera 10, a target subject image on the light-receiving surface 25A of the imaging element 25 fluctuates due to a change in positional relationship between the optical axis OA and the light-receiving surface 25A. In other words, it can be said that the term “shake” is a phenomenon in which an optical image, which is obtained by the image forming on the light-receiving surface 25A, fluctuates due to a tilt of the optical axis OA caused by the vibration applied to the camera 10. The fluctuation of the optical axis OA means that the optical axis OA is tilted with respect to, for example, a reference axis (for example, the optical axis OA before the shake occurs). Hereinafter, the shake that occurs due to the vibration will be simply referred to as “shake”.

The shake is included in the captured image as a noise component and affects image quality of the captured image. In order to remove the noise component included in the captured image due to the shake, the camera 10 comprises a lens-side shake correction mechanism 29, an imaging element-side shake correction mechanism 45, and an electronic shake correction unit 33, which are used for shake correction.

The lens-side shake correction mechanism 29 and the imaging element-side shake correction mechanism 45 are mechanical shake correction mechanisms. The mechanical shake correction mechanism is a mechanism that corrects the shake by applying, to a shake correction element (for example, anti-vibration lens 15B1 and/or imaging element 25), power generated by a driving source such as a motor (for example, voice coil motor) to move the shake correction element in a direction perpendicular to an optical axis of an imaging optical system.

Specifically, the lens-side shake correction mechanism 29 is a mechanism that corrects the shake by applying, to the anti-vibration lens 15B1, the power generated by the driving source such as the motor (for example, voice coil motor) to move the anti-vibration lens 15B1 in the direction perpendicular to the optical axis of the imaging optical system. The imaging element-side shake correction mechanism 45 is a mechanism that corrects the shake by applying, to the imaging element 25, power generated by a driving source such as a motor (for example, voice coil motor) to move the imaging element 25 in the direction perpendicular to the optical axis of the imaging optical system. The electronic shake correction unit 33 corrects the shake by performing image processing on the captured image based on a shake amount. That is, the shake correction unit (shake correction component) mechanically or electronically corrects the shake using a hardware configuration and/or a software configuration. The mechanical shake correction refers to the shake correction implemented by mechanically moving the shake correction element, such as the anti-vibration lens 15B1 and/or the imaging element 25, using the power generated by the driving source such as the motor (for example, voice coil motor). The electronic shake correction refers to the shake correction implemented by performing, for example, the image processing by a processor.

As shown in FIG. 4 as an example, the lens-side shake correction mechanism 29 comprises the anti-vibration lens 15B1, the lens actuator 17, the OIS driver 23, and a position sensor 39.

As a method of correcting the shake by the lens-side shake correction mechanism 29, various well-known methods can be employed. In the present embodiment, as the shake correction method, a shake correction method is employed in which the anti-vibration lens 15B1 is caused to move based on the shake amount detected by a shake amount detection sensor 40 (described below). Specifically, the anti-vibration lens 15B1 is caused to move, by an amount with which the shake cancels, in a direction of canceling the shake to correct the shake.

The lens actuator 17 is attached to the anti-vibration lens 15B1. The lens actuator 17 is a shift mechanism equipped with the voice coil motor and drives the voice coil motor to cause the anti-vibration lens 15B1 to fluctuate in the direction perpendicular to the optical axis of the anti-vibration lens 15B1. Here, as the lens actuator 17, the shift mechanism equipped with the voice coil motor is employed; however the technique of the present disclosure is not limited thereto. Instead of the voice coil motor, another power source such as a stepping motor or a piezo element may be employed.

The lens actuator 17 is controlled by the OIS driver 23. With the drive of the lens actuator 17 under the control of the OIS driver 23, the position of the anti-vibration lens 15B1 mechanically fluctuates in a two-dimensional plane perpendicular to the optical axis OA.

The position sensor 39 detects a current position of the anti-vibration lens 15B1 and outputs a position signal indicating the detected current position. Here, as an example of the position sensor 39, a device including a Hall element is employed. Here, the current position of the anti-vibration lens 15B1 refers to a current position in an anti-vibration lens two-dimensional plane. The anti-vibration lens two-dimensional plane refers to a two-dimensional plane perpendicular to the optical axis of the anti-vibration lens 15B1. In the present embodiment, the device including the Hall element is employed as an example of the position sensor 39; however the technique of the present disclosure is not limited thereto. Instead of the Hall element, a magnetic sensor, a photo sensor, or the like may be employed.

The lens-side shake correction mechanism 29 corrects the shake by causing the anti-vibration lens 15B1 to move along at least one of the direction of the pitch axis PA or the direction of the yaw axis YA in an actually imaged range. That is, the lens-side shake correction mechanism 29 causes the anti-vibration lens 15B1 to move in the anti-vibration lens two-dimensional plane by a movement amount corresponding to the shake amount to correct the shake.

The imaging element-side shake correction mechanism 45 comprises the imaging element 25, a body image stabilizer (BIS) driver 22, an imaging element actuator 27, and a position sensor 47.

In the same manner as the method of correcting the shake by the lens-side shake correction mechanism 29, various well-known methods can be employed as the method of correcting the shake by the imaging element-side shake correction mechanism 45. In the present embodiment, as the shake correction method, a shake correction method is employed in which the imaging element 25 is caused to move based on the shake amount detected by the shake amount detection sensor 40. Specifically, the imaging element 25 is caused to move, by an amount with which the shake cancels, in a direction of canceling the shake to correct the shake.

The imaging element actuator 27 is attached to the imaging element 25. The imaging element actuator 27 is a shift mechanism equipped with the voice coil motor and drives the voice coil motor to cause the imaging element 25 to fluctuate in the direction perpendicular to the optical axis of the anti-vibration lens 15B1. Here, as the imaging element actuator 27, the shift mechanism equipped with the voice coil motor is employed; however the technique of the present disclosure is not limited thereto. Instead of the voice coil motor, another power source such as a stepping motor or a piezo element may be employed.

The imaging element actuator 27 is controlled by the BIS driver 22. With the drive of the imaging element actuator 27 under the control of the BIS driver 22, the position of the imaging element 25 mechanically fluctuates in the direction perpendicular to the optical axis OA.

The position sensor 47 detects a current position of the imaging element 25 and outputs a position signal indicating the detected current position. Here, as an example of the position sensor 47, a device including a Hall element is employed. Here, the current position of the imaging element 25 refers to a current position in an imaging element two-dimensional plane. The imaging element two-dimensional plane refers to a two-dimensional plane perpendicular to the optical axis of the anti-vibration lens 15B1. In the present embodiment, the device including the Hall element is employed as an example of the position sensor 47; however the technique of the present disclosure is not limited thereto. Instead of the Hall element, a magnetic sensor, a photo sensor, or the like may be employed.

The camera 10 comprises a computer 19, a digital signal processor (DSP) 31, an image memory 32, the electronic shake correction unit 33, a communication I/F 34, the shake amount detection sensor 40, and a user interface (UI) system device 43. The computer 19 comprises a memory 35, a storage 36, and a central processing unit (CPU) 37.

The imaging element 25, the DSP 31, the image memory 32, the electronic shake correction unit 33, the communication I/F 34, the memory 35, the storage 36, the CPU 37, the shake amount detection sensor 40, and the UI system device 43 are connected to a bus 38. Further, the OIS driver 23 is connected to the bus 38. In the example shown in FIG. 4, one bus is illustrated as the bus 38 for convenience of illustration; however a plurality of buses may be used. The bus 38 may be a serial bus or may be a parallel bus such as a data bus, an address bus, and a control bus.

The memory 35 temporarily stores various types of information, and is used as a work memory. A random access memory (RAM) is exemplified as an example of the memory 35; however the present invention is not limited thereto. Another type of storage device may be used. The storage 36 stores various programs for the camera 10. The CPU 37 reads out various programs from the storage 36 and executes the readout various programs on the memory 35 to control the entire camera 10. Examples of the storage 36 include a flash memory, SSD, EEPROM, HDD, or the like. Further, for example, various non-volatile memories such as a magnetoresistive memory and a ferroelectric memory may be used instead of the flash memory or together with the flash memory.

The imaging element 25 is a complementary metal oxide semiconductor (CMOS) type image sensor. The imaging element 25 images a target subject at a predetermined frame rate under an instruction of the CPU 37. The term “predetermined frame rate” described herein refers to, for example, several tens of frames per second to several hundreds of frames per second. The imaging element 25 may incorporate a control device (imaging element control device). In this case, the imaging element control device performs detailed control inside the imaging element 25 in response to the imaging instruction output by the CPU 37. Further, the imaging element 25 may image the target subject at the predetermined frame rate under an instruction of the DSP 31. In this case, the imaging element control device performs detailed control inside the imaging element 25 in response to the imaging instruction output by the DSP 31. The DSP 31 may be referred to as an image signal processor (ISP).

The light-receiving surface 25A of the imaging element 25 is formed by a plurality of photosensitive pixels (not shown) arranged in a matrix. In the imaging element 25, each photosensitive pixel is exposed, and photoelectric conversion is performed for each photosensitive pixel. A charge obtained by performing the photoelectric conversion for each photosensitive pixel corresponds to an analog imaging signal indicating the target subject. Here, a plurality of photoelectric conversion elements (for example, photoelectric conversion elements in which color filters are disposed) having sensitivity to visible light are employed as the plurality of photosensitive pixels. In the imaging element 25, a photoelectric conversion element having sensitivity to R (red) light (for example, photoelectric conversion element in which an R filter corresponding to R is disposed), a photoelectric conversion element having sensitivity to G (green) light (for example, photoelectric conversion element in which a G filter corresponding to G is disposed), and a photoelectric conversion element having sensitivity to B (blue) light (for example, photoelectric conversion element in which a B filter corresponding to B is disposed) are employed as the plurality of photoelectric conversion elements. In the ground camera 10, the imaging based on the visible light (for example, light on a short wavelength side of about 700 nanometers or less) is performed by using these photosensitive pixels. However, the present embodiment is not limited thereto. The imaging based on infrared light (for example, light on a wavelength side longer than about 700 nanometers) may be performed. In this case, a plurality of photoelectric conversion elements having sensitivity to the infrared light may be used as the plurality of photosensitive pixels. In particular, for example, an InGaAs sensor and/or a simulation of type-II quantum well (T2SL) sensor may be used for short-wavelength infrared (SWIR) imaging.

The imaging element 25 performs signal processing such as analog/digital (A/D) conversion on the analog imaging signal to generate a digital image that is a digital imaging signal. The imaging element 25 is connected to the DSP 31 via the bus 38 and outputs the generated digital image to the DSP 31 in units of frames via the bus 38.

Here, the CMOS image sensor is exemplified for description as an example of the imaging element 25; however the technique of the present disclosure is not limited thereto. A charge coupled device (CCD) image sensor may be employed as the imaging element 25. In this case, the imaging element 25 is connected to the bus 38 via an analog front end (AFE) (not shown) that incorporates a CCD driver. The AFE performs the signal processing, such as A/D conversion, on the analog imaging signal obtained by the imaging element 25 to generate a digital image and output the generated digital image to the DSP 31. The CCD image sensor is driven by the CCD driver incorporated in the AFE. As a matter of course, the CCD driver may be independently provided.

The DSP 31 performs various types of digital signal processing on the digital image. For example, the various types of digital signal processing refer to demosaicing processing, noise removal processing, gradation correction processing, and color correction processing. The DSP 31 outputs the digital image after the digital signal processing to the image memory 32 for each frame. The image memory 32 stores the digital image from the DSP 31.

The shake amount detection sensor 40 is, for example, a device including a gyro sensor, and detects the shake amount of the camera 10. In other words, the shake amount detection sensor 40 detects the shake amount in each of a pair of axial directions. The gyro sensor detects a rotational shake amount around respective axes (refer to FIG. 1) of the pitch axis PA, the yaw axis YA, and a roll axis RA (axis parallel to the optical axis OA). The shake amount detection sensor 40 converts the rotational shake amount around the pitch axis PA and the rotational shake amount around the yaw axis YA, which are detected by the gyro sensor, into the shake amount in a two-dimensional plane parallel to the pitch axis PA and the yaw axis YA to detect the shake amount of the camera 10.

Here, the gyro sensor is exemplified as an example of the shake amount detection sensor 40. However this is merely an example, and the shake amount detection sensor 40 may be an acceleration sensor. The acceleration sensor detects the shake amount in the two-dimensional plane parallel to the pitch axis PA and the yaw axis YA. The shake amount detection sensor 40 outputs the detected shake amount to the CPU 37.

Further, although the form example is shown in which the shake amount is detected by a physical sensor called the shake amount detection sensor 40, the technique of the present disclosure is not limited thereto. For example, the movement vector obtained by comparing preceding and succeeding captured images in time series, which are stored in the image memory 32, may be used as the shake amount. Further, the shake amount to be finally used may be derived based on the shake amount detected by the physical sensor and the movement vector obtained by the image processing.

The CPU 37 acquires the shake amount detected by the shake amount detection sensor 40 and controls the lens-side shake correction mechanism 29, the imaging element-side shake correction mechanism 45, and the electronic shake correction unit 33 based on the acquired shake amount. The shake amount detected by the shake amount detection sensor 40 is used for the shake correction by each of the lens-side shake correction mechanism 29 and the electronic shake correction unit 33.

The electronic shake correction unit 33 is a device including an application specific integrated circuit (ASIC). The electronic shake correction unit 33 corrects the shake by performing the image processing on the captured image in the image memory 32 based on the shake amount detected by the shake amount detection sensor 40.

Here, the device including the ASIC is exemplified as the electronic shake correction unit 33; however the technique of the present disclosure is not limited thereto. For example, a device including a field programmable gate array (FPGA) or a programmable logic device (PLD) may be used. Further, for example, the electronic shake correction unit 33 may be a device including a plurality of ASICs, FPGAs, and PLDs. Further, a computer including a CPU, a storage, and a memory may be employed as the electronic shake correction unit 33. The number of CPUs may be singular or plural. Further, the electronic shake correction unit 33 may be implemented by a combination of a hardware configuration and a software configuration.

The communication I/F 34 is, for example, a network interface, and controls transmission of various types of information to and from the management apparatus 11 via a network. The network is, for example, a wide area network (WAN) or a local area network (LAN), such as the Internet. The communication I/F 34 performs communication between the camera 10 and the management apparatus 11.

The UI system device 43 comprises a reception device 43A and a display 43B. The reception device 43A is, for example, a hard key, a touch panel, and the like, and receives various instructions from a user. The CPU 37 acquires various instructions received by the reception device 43A and operates in response to the acquired instructions.

The display 43B displays various types of information under the control of the CPU 37. Examples of the various kinds of information displayed on the display 43B include a content of various instructions received by the reception device 43A and the captured image.

### <Configuration of Electrical System of Revolution Mechanism 16 and Management Apparatus 11>

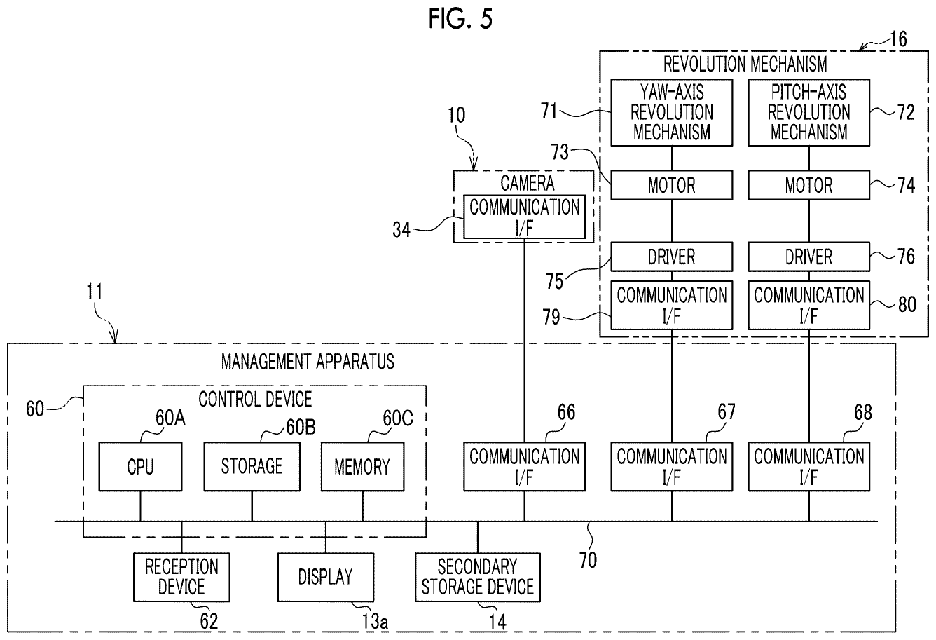

FIG. 5 is a diagram showing an example of a configuration of an electrical system of the revolution mechanism 16 and the management apparatus 11. As shown in FIG. 5 as an example, the revolution mechanism 16 comprises a yaw-axis revolution mechanism 71, a pitch-axis revolution mechanism 72, a motor 73, a motor 74, a driver 75, a driver 76, and communication I/Fs 79 and 80.

The yaw-axis revolution mechanism 71 causes the camera 10 to revolve in the yaw direction. The motor 73 is driven to generate the power under the control of the driver 75. The yaw-axis revolution mechanism 71 receives the power generated by the motor 73 to cause the camera 10 to revolve in the yaw direction. The pitch-axis revolution mechanism 72 causes the camera 10 to revolve in the pitch direction. The motor 74 is driven to generate the power under the control of the driver 76. The pitch-axis revolution mechanism 72 receives the power generated by the motor 74 to cause the camera 10 to revolve in the pitch direction.

The communication I/Fs 79 and 80 are, for example, network interfaces, and control transmission of various types of information to and from the management apparatus 11 via the network. The network is, for example, a WAN or a LAN, such as the Internet. The communication I/Fs 79 and 80 performs communication between the revolution mechanism 16 and the management apparatus 11.

As shown in FIG. 5 as an example, the management apparatus 11 comprises the display 13a, the secondary storage device 14, a control device 60, a reception device 62, and communication I/Fs 66, 67, and 68. The control device 60 comprises a CPU 60A, a storage 60B, and a memory 60C. The CPU 60A is an example of the processor in the embodiment of the present invention.

Each of the reception device 62, the display 13a, the secondary storage device 14, the CPU 60A, the storage 60B, the memory 60C, and the communication I/F 66 is connected to a bus 70. In the example shown in FIG. 5, one bus is illustrated as the bus 70 for convenience of illustration; however a plurality of buses may be used. The bus 70 may be a serial bus or may be a parallel bus including a data bus, an address bus, a control bus, and the like.

The memory 60C temporarily stores various types of information and is used as the work memory. An example of the memory 60C includes the RAM; however the present invention is not limited thereto. Another type of storage device may be employed. Various programs for the management apparatus 11 (hereinafter simply referred to as “programs for management apparatus”) are stored in the storage 60B.

The CPU 60A reads out the program for management apparatus from the storage 60B and executes the readout program for management apparatus on the memory 60C to control the entire management apparatus 11. The program for management apparatus includes an information processing program according to the embodiment of the present invention.

The communication I/F 66 is, for example, a network interface. The communication I/F 66 is communicably connected to the communication I/F 34 of the camera 10 via the network, and controls transmission of various types of information to and from the camera 10. The communication I/Fs 67 and 68 are, for example, network interfaces. The communication I/F 67 is communicably connected to the communication I/F 79 of the revolution mechanism 16 via the network, and controls transmission of various types of information to and from the yaw-axis revolution mechanism 71. The communication I/F 68 is communicably connected to the communication I/F 80 of the revolution mechanism 16 via the network, and controls transmission of various types of information to and from the pitch-axis revolution mechanism 72.

The CPU 60A receives the captured image, the imaging information, and the like from the camera 10 via the communication I/F 66 and the communication I/F 34. The CPU 60A controls the imaging operation of the imaging target region by the camera 10 via the communication I/F 66 and the communication I/F 34.

The CPU 60A controls the driver 75 and the motor 73 of the revolution mechanism 16 via the communication I/F 67 and the communication I/F 79 to control a revolution operation of the yaw-axis revolution mechanism 71. Further, the CPU 60A controls the driver 76 and the motor 74 of the revolution mechanism 16 via the communication I/F 68 and the communication I/F 80 to control the revolution operation of the pitch-axis revolution mechanism 72.

The CPU 60A receives the imaging target region of the camera 10 designated by the user. The CPU 60A determines an imaging method of the camera 10 that images the designated imaging target region a plurality of times according to the form of the imaging target region designated by the user.

The CPU 60A can receive designation of an imaging target region having a form other than a rectangular form, for example, as the form of the imaging target region. The form of the imaging target region includes, for example, a form of a region designated by a point group, a form of a region designated by a line, a form designated to surround a predetermined region. In a case where a region is designated by a point group, for example, only a part of the point may be imaged, the composition such as the pan/tilt angle or the angle of view may be determined to image the region between the points so as to be interpolated by connecting the points in the vicinity with a line segment or a curve, or the composition such as the pan/tilt angle or the angle of view may be determined to image the region between the points to be interpolated by connecting designated points with a line segment or a curve instead of the vicinity. In a case where the region is designated by a line, for example, imaging may be performed along the designated line segment. In a case where the region is designated to be surrounded, for example, only the designated region may be comprehensively imaged.

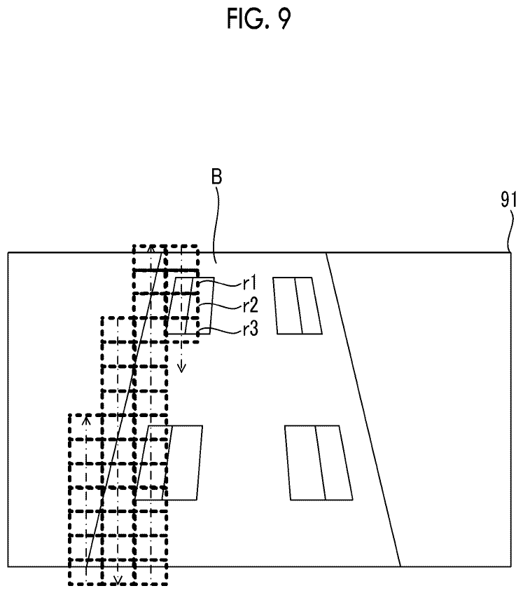

Determining the imaging method of the camera 10 that images the imaging target region includes, for example, determining each imaging region in a plurality of times of telephoto imaging by the camera 10. The respective imaging regions in the plurality of times of telephoto imaging are a plurality of imaging regions (for example, respective broken line regions r1, r2, and r3 shown in FIG. 9) determined by the set imaging angle of view and imaging position (pan/tilt value) of the camera 10.

In addition, the CPU 60A acquires data of a plurality of detailed partial images obtained by the plurality of times of telephoto imaging of the camera 10, and performs, for example, a resize processing in a reduction direction on the detailed partial images. The resize processing in the reduction direction is, for example, processing of reducing the size of the image by reducing the number of pixels. In addition, the CPU 60A generates a composite image (hereinafter, also referred to as an entire image) related to the entire imaging target region by performing the combining processing on the minified image subjected to the resize processing in the reduction direction. The detailed partial image is an example of a first image represented by the first image data according to the embodiment of the present invention. The composite image is an example of a second image represented by the second image data according to the embodiment of the present invention.

In addition, the CPU 60A generates the rectangular composite image by the resize processing and the combining processing in the reduction direction based on the detailed partial image not only in a case where the designation of the rectangular form is received as the form of the imaging target region but also in a case where the designation for a form other than the rectangular form is received.

The CPU 60A may generate the composite image by, for example, geometric processing of giving a geometric change different from reduction and enlargement to the detailed partial image, in addition to generating the composite image by the resize processing in the reduction direction and the combining processing based on the detailed partial image. The geometric processing includes, for example, rotation processing for the detailed partial image. The rotation processing is a projective transformation based on the imaging condition of the camera 10 in which the detailed partial image is obtained. The imaging condition of the camera 10 is a set angle of view and a pan/tilt value of the camera 10. In addition, the rotation processing includes processing of calculating a parameter for correcting an inclination (rotation distortion) of the angle of view of the camera 10 during the telephoto imaging.

The resize processing on the detailed partial image is resize processing including a geometric change. The resize processing including the geometric change is processing of generating a composite image by reduction processing based on the detailed partial image, geometric processing of giving a geometric change different from reduction and enlargement to the detailed partial image, and combining processing. The CPU 60A generates the composite image by performing processing in the order of the geometric processing, the reduction processing, and the combining processing.

In addition, the CPU 60A generates coordinate correspondence information in which relationships of the detailed partial image and the position of the detailed partial image in the composite image are associated with each other. The CPU 60A specifies a detailed partial image corresponding to a designated position (coordinates) in the composite image based on the coordinate correspondence information, and displays the specified detailed partial image on the display 13a. The coordinate correspondence information is stored in the memory 60C or the secondary storage device 14. The coordinate correspondence information is an example of first correspondence information according to the embodiment of the present invention.

In addition, in a case where the CPU 60A performs the resize processing in the reduction direction on the detailed partial image, the CPU 60A sets the reduction rate in the resize processing in the reduction direction based on the size of the composite image. The size of the composite image is the number of pixels in the vertical and horizontal directions in the composite image. The CPU 60A sets the reduction rate such that, for example, a composite image obtained by combining the minified image after reduction is inscribed in a rectangle having the size of the composite image. That is, in a case where the composite image is formed by arranging the plurality of minified images, the reduction rate is set such that the total number of pixels of the minified images is within the number of pixels of the composite image.

In addition, the CPU 60A generates revolution correspondence information in which the detailed partial image and the control value of the revolution mechanism 16 in a case of imaging in which the detailed partial image is obtained are associated with each other. The control values of the revolution mechanism 16 are pan and tilt control values of the camera 10 that is revolved by the revolution mechanism 16. The revolution correspondence information is stored in the memory 60C or the secondary storage device 14. In a case where the camera 10 is a camera having a zoom function, the revolution correspondence information may be generated by further associating the zoom position in a case of imaging with the control value of the revolution mechanism 16. The revolution correspondence information is an example of second correspondence information according to the embodiment of the present invention.

In addition, the CPU 60A outputs, for example, a control value corresponding to the designated detailed partial image among the plurality of detailed partial images to the revolution mechanism 16 or the like based on the revolution correspondence information. Accordingly, it is possible to easily re-capture a predetermined detailed partial image in the composite image with reference to the revolution correspondence information. For example, in a case where it is desired to inspect how the scratch on the wall surface of the building detected in the inspection a few days ago is currently, the user designates a predetermined inspection position in the composite image displayed on the display 13a, the control value corresponding to the partial image at the designated position is set in the revolution mechanism 16 based on the revolution correspondence information, and the partial image at the designated position can be re-captured.

In addition, the CPU 60A extracts a detailed partial image based on the degree of approximation of the designated control value among the plurality of detailed partial images based on the revolution correspondence information. As a result, for example, in a case where there are a plurality of sets of “plurality of detailed partial images” having different imaging times and one detailed partial image of a certain set is designated, it is possible to extract a detailed partial image of a control value similar to the detailed partial image from the other set. For example, in a case where the wall surface of the building is inspected every six months, in a case where the user wants to detect how the scratch on the wall surface detected in the past has changed every six months, the user designates a predetermined confirmation position in the composite image displayed on the display 13a, and the detailed partial images for a plurality of times in the past corresponding to the control value of the designated confirmation position are extracted based on the revolution correspondence information, and the plurality of detailed partial images extracted for a plurality of times can be checked.

In addition, the CPU 60A acquires distance measurement information of a plurality of positions in the imaging target region in a smaller number of times than the number of times of imaging the imaging target region a plurality of times, and acquires a plurality of detailed partial images by imaging the imaging target region a plurality of times based on the distance measurement information acquired a plurality of times. Specifically, the CPU 60A calculates the distance measurement information of the position that is not measured based on the distance measurement information of the measured position, and acquires a plurality of detailed partial images by imaging the imaging target region a plurality of times based on the distance measurement information including the calculated distance measurement information. The distance measurement information is an imaging distance or a focus position at which the imaging is in focus.

The reception device 62 is, for example, the keyboard 13b, the mouse 13c, and a touch panel of the display 13a, and receives various instructions from the user. The CPU 60A acquires various instructions received by the reception device 62 and operates in response to the acquired instructions. For example, in a case where the reception device 62 receives a processing content for the camera 10 and/or the revolution mechanism 16, the CPU 60A causes the camera 10 and/or the revolution mechanism 16 to operate in accordance with an instruction content received by the reception device 62.

The display 13a displays various types of information under the control of the CPU 60A. Examples of the various kinds of information displayed on the display 13a include contents of various instructions received by the reception device 62 and the captured image or imaging information received by the communication I/F 66. The CPU 60A causes the display 13a to display the contents of various instructions received by the reception device 62 and the captured image or imaging information received by the communication I/F 66.

The secondary storage device 14 is, for example, a non-volatile memory and stores various types of information under the control of the CPU 60A. Examples of the various types of information stored in the secondary storage device 14 include the captured image or imaging information received by the communication I/F 66. The CPU 60A stores the captured image or imaging information received by the communication I/F 66 in the secondary storage device 14.

### <Imaging Processing and Image Processing by CPU 60A of Management Apparatus 11>

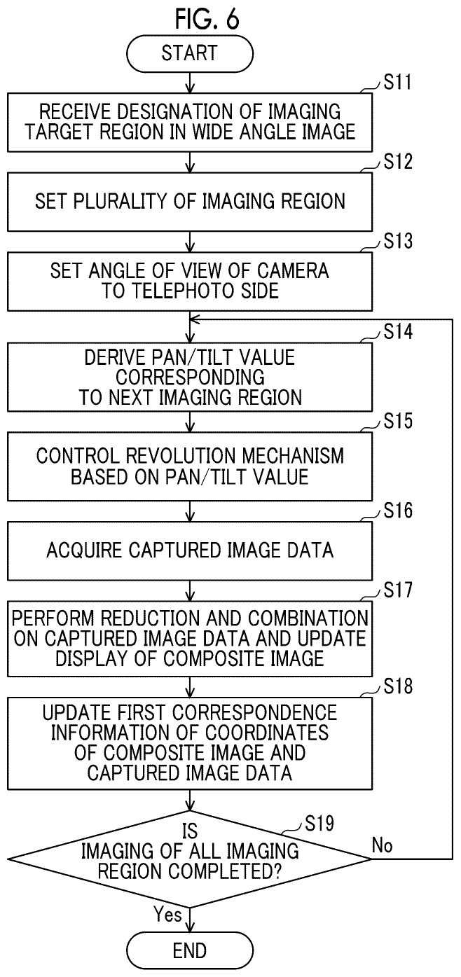

FIG. 6 is a flowchart showing an example of “imaging processing of imaging target region” and “combining processing of composite image” by the CPU 60A of the management apparatus 11.

It is assumed that inspection work of an infrastructure (a wall surface of a building, a power transmission line, a windmill, or the like) is performed using the camera 10. The camera 10 is installed toward an imaging target, and a zoom position of a zoom lens is set to a wide angle end. Data of the wide angle image captured by the camera 10 is transmitted to the management apparatus 11 via the communication line 12. In a case where the imaging target cannot be completely imaged even in a case where the camera 10 is set to the wide angle end, the imaging target may be imaged by using the wide angle camera provided in the camera 10.

An operator (user) is present in front of the management apparatus 11 and is viewing the captured image of the camera 10 displayed on the display 13a. The operator performs the inspection work while operating the camera 10 through the communication line 12 by operating the keyboard 13b or the mouse 13c of the management apparatus 11 or performing a touch operation on the display 13a.

The CPU 60A of the management apparatus 11 starts the processing shown in FIG. 6 in response to the designation operation of the inspection region (imaging target region) from the operator in a state in which the wide angle image is displayed on the display 13a.

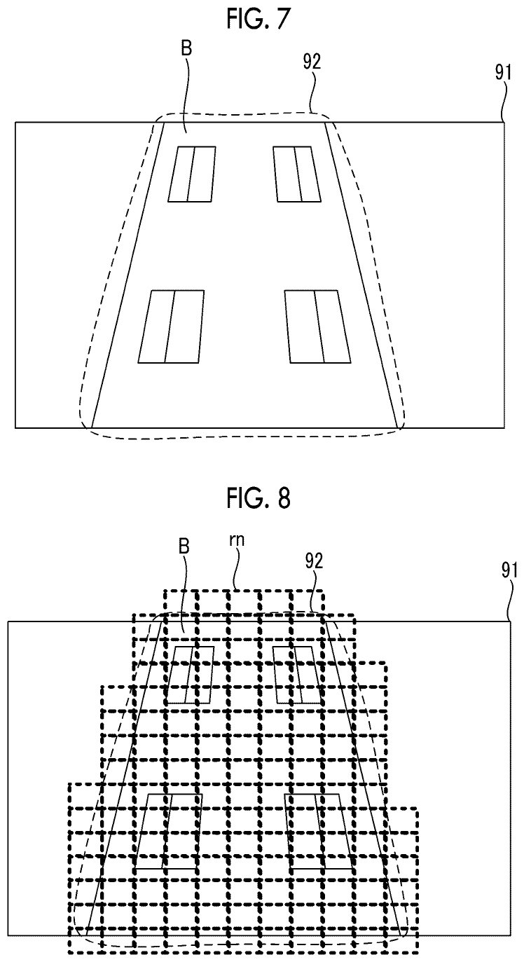

The CPU 60A receives the designation of the imaging target region in the wide angle image displayed on the display 13a (step S11). As described above, the designation of the imaging target region includes a form in which the region of the imaging target is designated by a point group with respect to the wide angle image displayed on the display 13a, a form in which the region of the imaging target is designated by a line, a form in which the region of the imaging target is designated by surrounding a predetermined region, and the like. The designation of the imaging target region will be specifically described later with reference to FIG. 7.

Next, the CPU 60A sets a plurality of imaging regions for the imaging target region designated in step S11 (step S12). Since the size of the imaging region that can be imaged by the telephoto imaging of the camera 10 is determined by the setting with respect to the wide angle image displayed on the display 13a, a plurality of imaging regions are set based on the size. The plurality of imaging regions are set in an arrangement in which the designated imaging target region is included in at least the plurality of imaging regions. The setting of the plurality of imaging regions will be specifically described later with reference to FIG. 8.

Next, the CPU 60A sets the angle of view of the camera 10 to the telephoto side in order to image each of the plurality of imaging regions set in step S12 (step S13). For example, the CPU 60A sets a zoom position of the zoom lens of the camera 10 to a telephoto end. However, since a scratch or a crack on a wall surface or the like of the building may be large and may not fit in one image in a case where the camera 10 is set to the telephoto end, the zoom position may be designated by the operator.

Next, the CPU 60A derives the pan/tilt value corresponding to the next imaging region in the plurality of imaging regions arranged to include the imaging target region (step S14). Since the coordinates of each of the plurality of imaging regions arranged on the wide angle image displayed on the display 13a and the pan/tilt value can be calculated based on the size and positional relationship of the wide angle image and the imaging region, the coordinates and the pan/tilt value are calculated in advance and stored in the memory 60C or the secondary storage device 14 as correspondence information. The CPU 60A derives the pan/tilt value corresponding to the next imaging region based on the correspondence information calculated in advance.

Next, the CPU 60A controls the revolution operation of the revolution mechanism 16 based on the pan/tilt value derived in step S14 (step $15). Specifically, as described above, the CPU 60A controls the revolution operation of the yaw-axis revolution mechanism 71 and the revolution operation of the pitch-axis revolution mechanism 72 in the revolution mechanism 16. In a case where the CPU 60A controls the revolution mechanism 16, the CPU 60A may perform distance measurement and focusing of the imaging region before capturing a detailed partial image of the imaging region.

Next, the CPU 60A acquires the captured image data (detailed partial image) of the imaging region specified by the revolution control in step S15 (step S16). In a case where the imaging direction of the camera 10 is set by the revolution control of step S15, the CPU 60A outputs, for example, an imaging instruction signal for instructing the camera 10 to image the imaging region. The CPU 60A acquires captured image data of the imaging region captured by the camera 10. The acquisition of the captured image data will be specifically described later with reference to FIGS. 9 and 10.

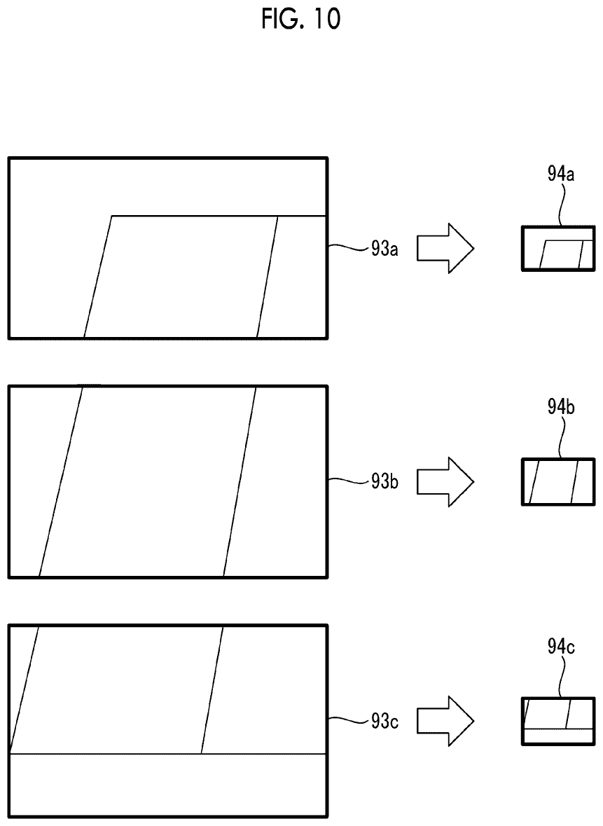

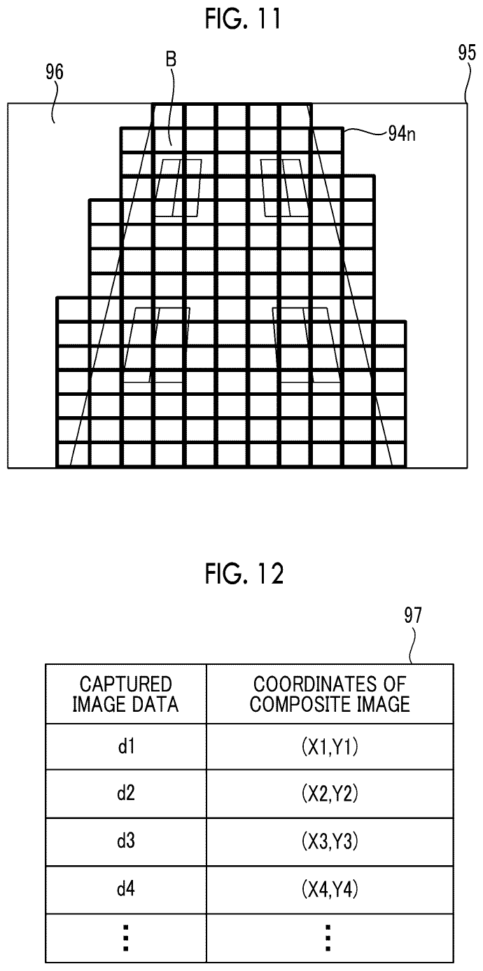

Next, the CPU 60A performs reduction processing on the captured image data of the detailed partial image acquired in step S16 and performs the combining processing on the minified image obtained by the reduction processing to update the display of the composite image composed of the minified image (step S17). In the present example, a method of updating the combination of the composite image by adding the minified image each time the captured image data is acquired is employed. However, for example, after the captured image data of the plurality of imaging regions is acquired, a composite image may be created using the plurality of pieces of captured image data. The reduction and combination of the captured image data will be specifically described later with reference to FIGS. 10 and 11.

Next, in a case in which the display of the composite image is updated by adding the minified image in step S17, the CPU 60A updates the coordinate correspondence information by adding information indicating a correspondence relationship between the coordinates of the added minified image on the composite image and the captured image data of the detailed partial image acquired in step S16 (step S18). The coordinate correspondence information will be specifically described later with reference to FIG. 12. In the present example, the coordinate correspondence information is updated (step S18) after the display of the composite image is updated (step S17); however the order of these processes may be changed. That is, the update processing of the display of the composite image may be performed after the update processing of the coordinate correspondence information is performed first.

Next, the CPU 60A determines whether or not all of the imaging of the plurality of imaging regions set in step S12 are completed (step S19).

In step S19, in a case where the imaging of all the set plurality of imaging regions is not completed (step S19: No), the CPU 60A returns to step S14 and repeats each processing. In step S19, in a case where the imaging of all of the set plurality of imaging regions is completed (step S19: Yes), the CPU 60A ends the main processing.

### <Designation of Imaging Target Region>

FIG. 7 is a diagram showing an example of designation of an imaging target region 92 in the wide angle image 91. As shown in FIG. 7, in the present example, the inspection of the infrastructure is a case of inspecting the presence or absence of a scratch or a crack on the wall surface of the building B. The wide angle image 91 is an image captured by the camera 10 and is displayed on the display 13a of the management apparatus 11. The operator designates a region to be inspected as the imaging target region 92 by performing a touch operation on the display 13a. The designation of the imaging target region 92 may be, for example, a designation by freehand or a designation by a polygonal shape. In the example shown in the figure, the imaging target region 92 is shown to surround the building B to be inspected by the freehand designation. The range of the imaging target region is not limited to the entire building B, and can be set to a range of any size.

### <Setting of Imaging Region for Imaging Target Region 92>

FIG. 8 is a diagram showing an example in which a plurality of imaging regions rn captured by telephoto imaging with the camera 10 for the imaging target region 92 designated in FIG. 7 are set. The plurality of imaging regions rn are arranged such that the imaging target region 92 is included inside the plurality of imaging regions rn. The size of one imaging region rn is determined, for example, by a telephoto setting degree of the camera 10. The plurality of imaging regions rn are arranged in a rectangular grid pattern vertically and horizontally, and adjacent imaging regions rn are arranged to slightly overlap each other.

<Acquisition of Captured Image Data of Imaging Region rn>

FIG. 9 is a diagram showing an example of a state in which the plurality of imaging regions rn set in FIG. 8 are sequentially imaged by the camera 10 by telephoto imaging. In the present example, as shown by the arrows in FIG. 9, the captured image data of each imaging region is acquired while sequentially imaging each column from the right column (left column as viewed from the camera 10) to the left column (right column as viewed from the camera 10) of the building B in the plurality of imaging regions rn shown in FIG. 8 in the vertical direction. For example, in the imaging region in the fourth column from the right, the captured image data is acquired in the order of the imaging region r1, the imaging region r2, and the imaging region r3 while tilting from the upper part to the lower part of the building B.

### <Reduction Processing of Captured Image>

FIG. 10 is a diagram showing detailed partial images 93a, 93b, and 93c generated by the captured image data of the imaging regions r1, r2, and r3 acquired in FIG. 9, and minified images 94a, 94b, and 94c generated based on the detailed partial images 93a, 93b, and 93c. The detailed partial images 93a, 93b, and 93c (hereinafter, also referred to as detailed partial images 93n) are high-quality images obtained by telephoto imaging of the imaging regions r1, r2, and r3 by the camera 10 as described above. As described above, the minified images 94a, 94b, and 94c are images generated by performing the reduction processing on the detailed partial images 93a, 93b, and 93c. The reduction processing includes reduction processing of reducing the size and reduction processing of reducing the number of pixels. Specifically, the minified image 94a is an image generated by performing reduction processing of reducing the number of pixels of the detailed partial image 93a to reduce the size. The minified image 94b is an image generated by performing reduction processing of reducing the number of pixels of the detailed partial image 93b to reduce the size. The minified image 94c is an image generated by performing reduction processing of reducing the number of pixels of the detailed partial image 93c to reduce the size.

### <Generation of Composite Image>

FIG. 11 is a diagram illustrating a composite image 95 generated by the minified images 94a, 94b, 94c, and the like (hereinafter, also referred to as minified images 94n) generated in FIG. 10. The composite image 95 is generated by performing a combining processing on the minified image 94n. As described above, the combining processing of the composite image 95 is updated each time the minified image 94n is generated, and for example, in a case where the minified image 94a is generated based on the detailed partial image 93a, the generated minified image 94a is fitted to a position corresponding to the imaging region r1 from which the detailed partial image 93a is acquired, and the combining processing is performed. Next, the combining processing is performed by fitting the minified image 94b at a position corresponding to the imaging region r2 in a case where the minified image 94b is generated based on the detailed partial image 93b. Next, the combining processing is performed such that the minified image 94c is fitted at a position corresponding to the imaging region r3 in a case where the minified image 94c is generated based on the detailed partial image 93c. In addition, as shown in FIG. 11, in the composite image 95, a region other than the region in which the minified image 94n is displayed is displayed as a background region 96. The background region 96 is displayed, for example, in the same color as the color of the end part of the composite image 95.

### <Generation of Coordinate Correspondence Information>

FIG. 12 is an example of coordinate correspondence information 97 indicating a correspondence relationship between the captured image data of the imaging region rn acquired in FIG. 9 and coordinates of the detailed partial image 93n generated from the captured image data on the composite image 95. As described above, the coordinate correspondence information 97 is updated each time the detailed partial image 93n of each imaging region rn is captured and the captured image data is acquired. The coordinates of the composite image 95 indicate coordinates corresponding to the center position of the detailed partial image 93n. For example, coordinates (X1, Y1) of the composite image corresponding to the captured image data dl are coordinates corresponding to a center position of the detailed partial image 93n generated based on the captured image data d1.

### <Image Display Processing by CPU 60A of Management Apparatus 11>

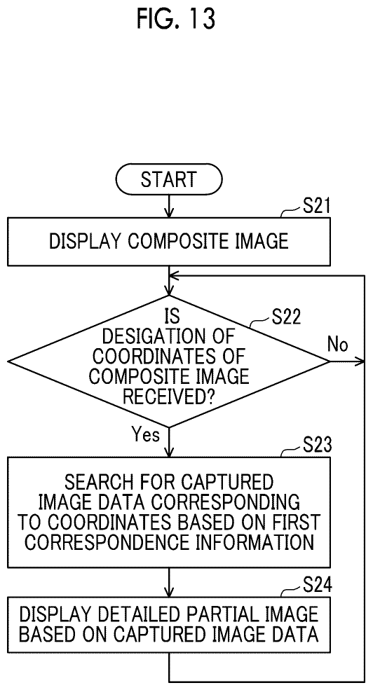

FIG. 13 is a flowchart showing an example of display processing of the “composite image and detailed partial image” by the CPU 60A of the management apparatus 11. After the imaging of all the imaging regions is completed in the processing shown in FIG. 6, the CPU 60A of the management apparatus 11 starts the processing shown in FIG. 13 in response to an operation of the keyboard 13b or the mouse 13c from the operator for checking the captured image.

First, the CPU 60A displays the composite image 95 on the display 13a (step S21).

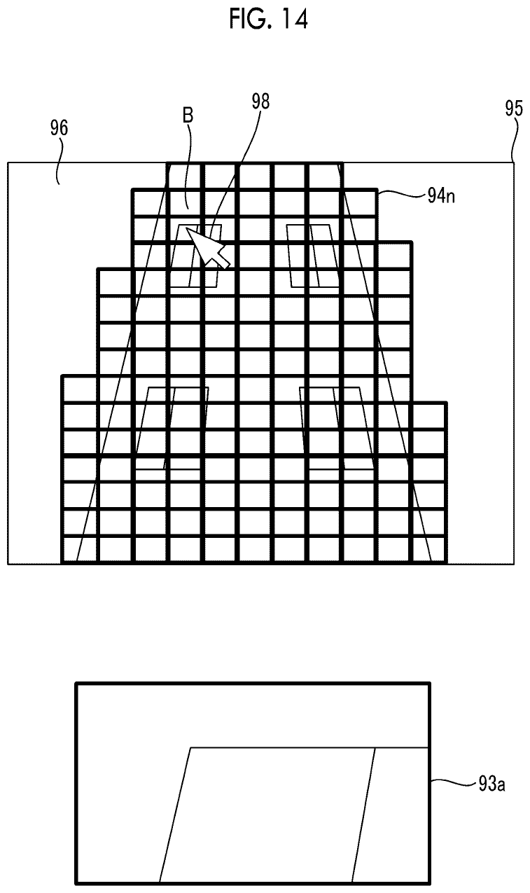

Next, the CPU 60A determines whether or not the designation of the coordinates from the operator is received for the composite image 95 displayed on the display 13a (Step S22). The reception of designation is, for example, reception of a click operation by the mouse 13c of the operator. The designation in the composite image 95 will be specifically described later with reference to FIG. 14.

In step S22, in a case where the designation of the coordinates of the composite image 95 is not received (step S22: No), the CPU 60A waits until the designation is received.

In step S22, in a case where the designation of the coordinates of the composite image 95 is received (step S22: Yes), the CPU 60A searches for the captured image data corresponding to the designated coordinates based on the coordinate correspondence information 97 (refer to FIG. 12) (step S23). The captured image data corresponding to the designated coordinates is, for example, captured image data associated with a coordinate value closest to the designated coordinate value.

Next, the CPU 60A displays the detailed partial image 93n generated based on the captured image data searched for in step S23 on the display 13a (step S24). The detailed partial image 93n may be displayed in a window different from the composite image 95, or the composite image 95 and the detailed partial image 93n may be displayed by being switched. Alternatively, the detailed partial image 93n may be displayed on a display different from the display 13a on which the composite image 95 is displayed. The display of the detailed partial image 93n will be specifically described later with reference to FIG. 14. The CPU 60A displays the detailed partial image 93n, returns to step S22, and determines whether or not the next designation is received.

<Coordinate Designation of Composite Image 95 and Display of Detailed Partial Image 93n>

FIG. 14 is a diagram showing an example of the designation of the inspection location in the composite image 95 and the detailed partial image 93n displayed based on the designated position. As shown in FIG. 14, a designation of the coordinates of the composite image 95 indicated by the mouse cursor 98 is received by moving the mouse cursor 98 to the portion of the building B to be inspected on the composite image 95 and clicking. In a case where the designation of the coordinates in the composite image 95 is received, the captured image data corresponding to the coordinate value closest to the designated coordinate value is readout from the captured image data dn (refer to FIG. 12) stored as the coordinates (Xn, Yn) of the composite image. Then, for example, a detailed partial image 93a is generated based on the readout captured image data. The generated detailed partial image 93a is displayed on the display 13a in a window different from the composite image 95, for example.

As described above, the CPU 60A of the management apparatus 11 determines the imaging method of imaging the imaging target region 92 by the plurality of imaging operations according to the form of the designated imaging target region 92, acquires the plurality of detailed partial images 93n obtained by the imaging using the determined imaging method, and performs the resize processing in the reduction direction and the combining processing on the acquired detailed partial images 93n to generate the composite image 95 related to the imaging target region 92. According to this configuration, it is possible to determine the imaging method according to the form of the designated imaging target region and to perform the inspection work using the composite image 95 generated by performing the resize processing in the reduction direction and the combining processing on the detailed partial image 93n that has been captured. Therefore, in the inspection work of the imaging target region 92, it is possible to reduce the required resources of the management apparatus 11. In addition, since it is possible to reduce the imaging time by imaging only the designated imaging target region 92, it is possible to shorten the time of the inspection work.

In addition, the CPU 60A can receive designation for a form other than a rectangular form as the form of the imaging target region. Therefore, it is possible to designate only a region of any form that requires inspection as the imaging target region, and it is possible to perform imaging only for a region that requires inspection. Therefore, it is possible to shorten the time for inspection work.

In addition, the CPU 60A stores coordinate correspondence information 97 in which the positional relationship of the detailed partial image 93n in the composite image 95 is associated with each partial image 93n. Therefore, since the detailed partial image 93n of the position designated as the inspection region can be displayed based on the coordinate correspondence information 97, it is possible to perform the work using an appropriate partial image 93n, and it is possible to shorten the time for the inspection work.

In addition, by designating any inspection location on the composite image 95 with, for example, the mouse cursor 98, the image data of the detailed partial image 93n corresponding to the designated position can be readout, and the detailed partial image 93n can be displayed on the display 13a together with the composite image 95. Therefore, it is possible to easily recognize the positional relationship of the image of the inspection position with respect to the entire image, and it is possible to shorten the work time.

### <Other Examples of Inspection Target>

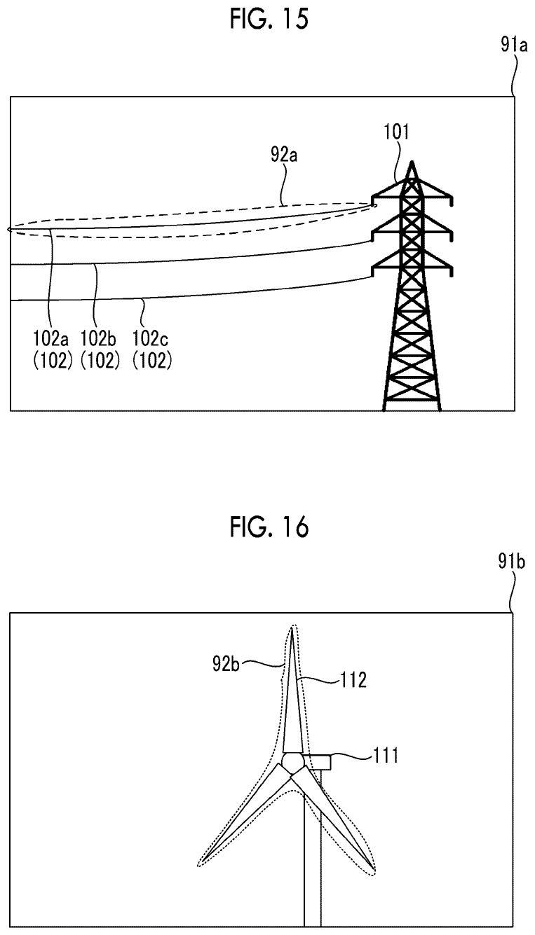

FIG. 15 is a diagram showing an example of a case where the electric wire 102 of the transmission tower 101 is inspected. As shown in FIG. 15, the wide angle image 91a of the electric wire 102 and the transmission tower 101 captured by the camera 10 is displayed on the display 13a of the management apparatus 11. In the example shown in the drawing, three electric wires 102a, 102b, and 102c are connected between the transmission tower 101 and a transmission tower (not shown) adjacent to the transmission tower 101. In addition, the imaging target region 92a indicating the imaging range is designated as a laterally long region by the touch operation on the display 13a by the operator in a freehand manner to surround the electric wire 102a which is the inspection target. In a case where the imaging target region 92a is designated as the laterally long region in this way, the plurality of imaging regions rn are arranged in a laterally long shape along the imaging target region 92a. Then, the captured image data is acquired while performing telephoto imaging of the plurality of imaging regions rn arranged in a laterally long shape in order.

FIG. 16 is a diagram showing an example of a case in which the blade 112 of the windmill 111 is inspected. As shown in FIG. 16, the wide angle image 91b of the windmill 111 captured by the camera 10 is displayed on the display 13a of the management apparatus 11. In the example shown in the figure, three blades 112 are provided in the windmill 111. In addition, the three blades 112 are set as the inspection target, and the imaging target region 92b indicating the imaging range is designated as a region having a substantially triangular shape surrounding the three blades 112 to be inspected by the operator's touch operation on the display 13a in a freehand manner. In a case where the imaging target region 92b is designated as a triangular region in this way, the plurality of imaging regions rn are arranged in a triangular shape such that the imaging target region 92b is included inside the plurality of imaging regions rn. Then, the captured image data is acquired while performing telephoto imaging of the plurality of imaging regions rn arranged in a triangular shape in order.

### <Other Designation Example of Imaging Target Region>

In the examples of FIGS. 7, 15, and 16 described above, the form has been described in which the imaging target regions 92, 92a, and 92b are designated by surrounding the region to be imaged with a line; however, for example, the designation may be performed in the following form.

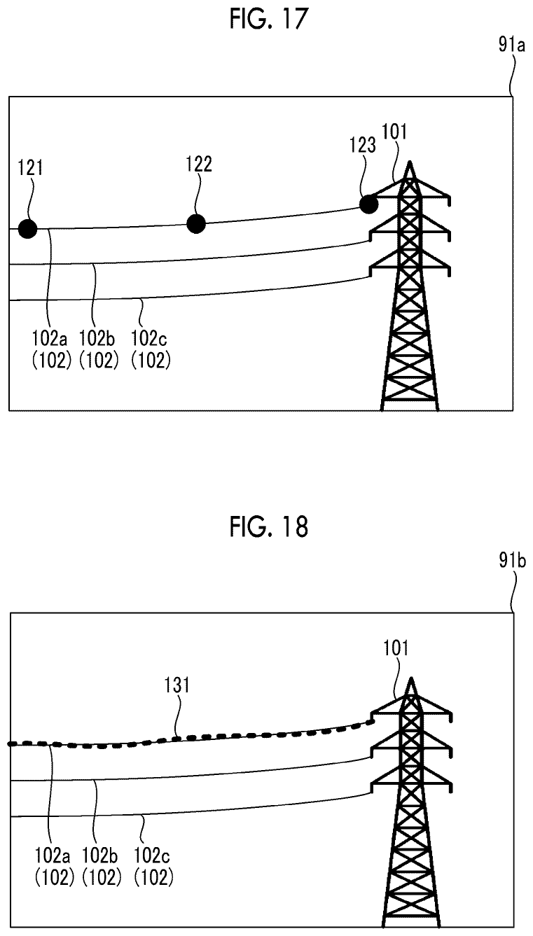

FIG. 17 is a diagram illustrating an example in which the imaging target region is designated by a point group. In a case where the imaging target region is designated by a point group, as shown in FIG. 17, the imaging target region is designated on the electric wire 102a to be inspected, for example, as the imaging target points 121, 122, and 123. In a case where the imaging target region is designated by the point groups (imaging target points 121, 122, and 123), the positional information of the electric wire 102a between the imaging target points 121, 122, and 123 is interpolated based on the positional information of the imaging target points 121, 122, and 123 in consideration of the fact that the electric wire 102 of the transmission tower 101 draws a specific curve. Then, based on the positional information of the imaging target points 121, 122, and 123 and the calculated positional information of the electric wires 102a between the imaging target points 121, 122, and 123, a laterally long imaging target region surrounding the electric wire 102a similar to the imaging target region 92a shown in FIG. 15 is determined. In addition, as a method of generating the laterally long imaging target region surrounding the electric wire 102a based on the imaging target points 121, 122, and 123, for example, information such as the electric wire designation mode may be prepared, or image recognition using machine learning may be used.

FIG. 18 is a diagram showing an example in which the imaging target region is designated by a line. In a case where the imaging target region is designated by a line, as shown in FIG. 18, the imaging target region is designated as, for example, an imaging target line 131 along the electric wire 102a to be inspected. In a case where the imaging target region is designated by a line (imaging target line 131), in consideration of the fact that the electric wire 102 of the transmission tower 101 draws a specific curve, a laterally long imaging target region similar to the imaging target region 92a shown in FIG. 15 is determined to include the imaging target line 131 along the imaging target line 131. In addition, as a method of generating the laterally long imaging target region surrounding the electric wire 102a based on the imaging target line 131, for example, information such as an electric wire designation mode may be prepared, or image recognition using machine learning may be used.

### <Interpolation Processing in Case Where Imaging Target Region is Designated by Point Group>

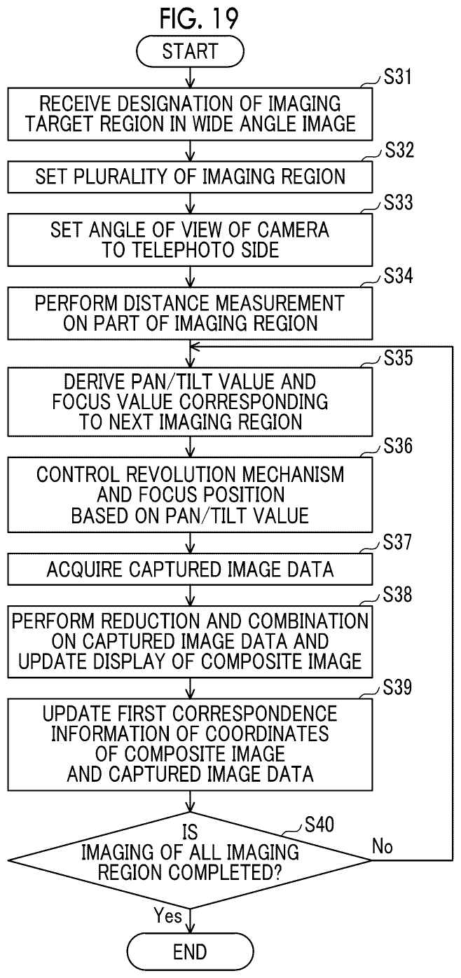

FIG. 19 is a flowchart showing an example of “imaging processing of the imaging target region” and “combining processing of the composite image” in a case where the imaging target region is designated by the point group.

It is assumed that the inspection work of the power transmission line is performed using the camera 10. The camera 10 is installed toward an imaging target, and a zoom position of a zoom lens is set to a wide angle end. The wide angle image captured by the camera 10 is displayed on the display 13a of the management apparatus 11 (for example, refer to FIG. 17).

The CPU 60A of the management apparatus 11 starts the processing shown in FIG. 19 in response to the operation of designating the inspection region (imaging target region) from the operator with respect to the wide angle image of the transmission tower 101 and the electric wire 102 displayed on the display 13a. In the present example, the imaging target region is designated by a point group.

Each processing from step S31 to step S33 in FIG. 19 is the same as each processing from step S11 to step S13 described in FIG. 6, and thus the description thereof will be omitted.

Next, the CPU 60A measures the distance to a part of the imaging regions rn among the plurality of imaging regions rn set in step S32 (step S34). The distance measurement of a part of the imaging region rn is performed by the operator. The CPU 60A prompts the operator to perform distance measurement using the autofocus button for a part of the imaging regions rn. The operator, for example, performs the distance measurement of the imaging region rn including the imaging target points 121, 122, and 123 (refer to FIG. 17) designated as the imaging target region.

Next, the CPU 60A derives the pan/tilt value and the focus value corresponding to the next imaging region in the plurality of imaging regions arranged to include the imaging target region (step S35). The coordinates of each of the plurality of imaging regions arranged on the wide angle image displayed on the display 13a and the pan/tilt value are calculated based on the size and positional relationship of the wide angle image and the imaging region. In addition, the focus value of the imaging region rn arranged between the imaging target points 121, 122, and 123 is calculated using the focus value of the imaging region rn including the imaging target points 121, 122, and 123 obtained by the distance measurement in step S34. The calculated pan/tilt value and focus value are stored in the memory 60C or the secondary storage device 14 as correspondence information in association with each coordinate of the imaging region. The CPU 60A derives the pan/tilt value and the focus value corresponding to the next imaging region based on the correspondence information calculated in advance.

Next, the CPU 60A controls the revolution operation of the revolution mechanism 16 based on the pan/tilt value derived in step S35 and controls the focus position of the camera 10 based on the derived focus value (step S36).

Each processing from step S37 to step S40 in FIG. 19 is the same as each processing from step S16 to step S19 in FIG. 6, and thus the description thereof will be omitted.

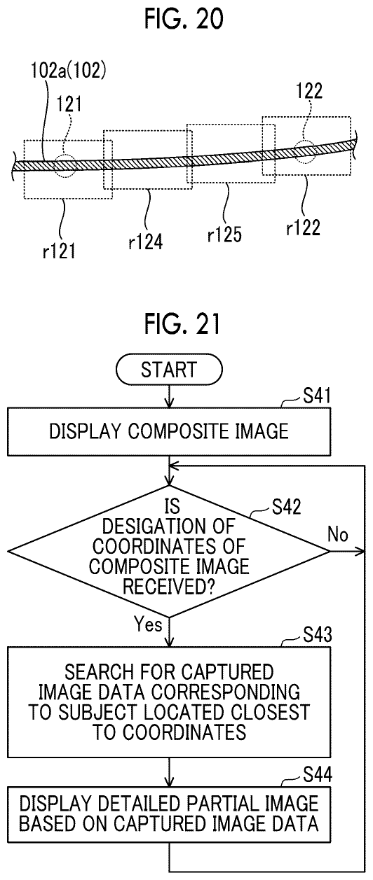

FIG. 20 is a diagram showing interpolation processing between imaging regions in a case where the imaging target region is designated by a point group. As shown in FIG. 20, the imaging region rn including the designated imaging target points 121 and 122 in the imaging target region of the electric wire 102a described in FIG. 19 is arranged in a laterally long shape, for example, as imaging regions r121, r122, r124, and r125. The imaging region r121 including the imaging target point 121 and the imaging region r122 including the imaging target point 122 are imaging regions in which the focus value is obtained by the distance measurement by the operation of the autofocus button of the operator. On the other hand, the imaging regions r124 and r125 arranged between the imaging regions r121 and r122 are imaging regions arranged based on the imaging regions r121 and r122, and are imaging regions for which the focus value is not obtained. In this case, the focus values of the imaging regions r124 and r125 are calculated by using the focus values of the imaging regions r121 and r122 obtained by distance measurement.

As described above, the focus value is obtained by performing the distance measurement of a part of the imaging regions rn, and the focus value of the imaging region rn other than the part is calculated by using the focus value, so that it is possible to reduce the number of times the operator performs the operation of the autofocus or the manual focus. Accordingly, it is possible to smoothly image the imaging target region and to shorten the time for the inspection work.

By the way, in a case where the imaging target is a power transmission line as shown in FIG. 20 or a wall surface of the building B as shown in FIG. 7, the imaging target region is on a surface parallel to the direction of gravitational force (vertical direction). Therefore, in order to obtain the focus information of the imaging region for which the focus information is not obtained in advance, the focus information can be calculated based on the focus information of other imaging regions obtained in advance on the same parallel surface. On the other hand, in a case where the imaging target is, for example, a blade 112 of a windmill 111 as shown in FIG. 16, the imaging target region (the surface of the blade 112) is often composed of an oblique surface or a curved surface in the direction of gravitational force. Such a configuration is not limited to the blade 112 of the windmill 111, and the same applies to, for example, an imaging target region of a bridge or a tunnel. Therefore, the focus information obtained by distance measurement in advance may be stored according to the characteristics of the imaging target, and the focus information of the imaging target may be calculated using the approximate focus information from the stored focus information in a case where the characteristics of the imaging target are detected during imaging in the actual inspection. As a result, the time for inspection work of various infrastructures can be shortened.

### <Image Display Processing in Case Where Imaging Target Region is Designated by Point Group>

FIG. 21 is a flowchart showing an example of a display processing of a “composite image and a detailed partial image” in a case where the imaging target region is designated by a point group.

After the imaging of all the imaging regions is completed in the processing shown in FIG. 19, the CPU 60A of the management apparatus 11 starts the processing shown in FIG. 21 in response to an operation of the keyboard 13b or the mouse 13c from the operator for checking the captured image. Since FIG. 19 is processing of performing the inspection work of the power transmission line, in the case of the present example, the composite image of the electric wire 102a is displayed on the display 13a.

Each processing in step S41, step S42, and step S44 in FIG. 21 is the same as each processing in step S21, step S22, and step S24 described in FIG. 13, and thus the description thereof will be omitted.

In step S42, in a case where the designation of the coordinates of the composite image 95 is received (step S42: Yes), the CPU 60A searches for the captured image data corresponding to the subject (electric wire 102a) closest to the designated coordinates based on the coordinate correspondence information 97 (refer to FIG. 12) (step S43). However, as described above, the plurality of imaging regions rn are arranged such that adjacent imaging regions rn slightly overlap each other. Therefore, the subject (electric wire 102a) closest to the designated coordinates may be located in an overlapping region of the adjacent imaging regions rn and may be included in the plurality of imaging regions rn. Therefore, the CPU 60A specifies a region of the subject in the composite image in advance by image recognition. In a case where the designation of the coordinates of the composite image is received, the CPU 60A extracts the captured image data of the imaging region rn overlapping a certain range centered on the designated coordinates as a candidate. The number of imaging regions rn that overlap with a certain range centered on the designated coordinates may be plural. In a case where the number of the extracted imaging regions rn is plural, the captured image data of, for example, the imaging region rn having the largest occupied area of the subject is searched from among the plurality of imaging regions rn based on the coordinate correspondence information 97. It should be noted that, for example, the captured image data of the imaging region rn having the highest contrast or the imaging region rn having the highest score by the scratch detection result by artificial intelligence (AI) or the like may be searched for from among the plurality of imaging regions rn.

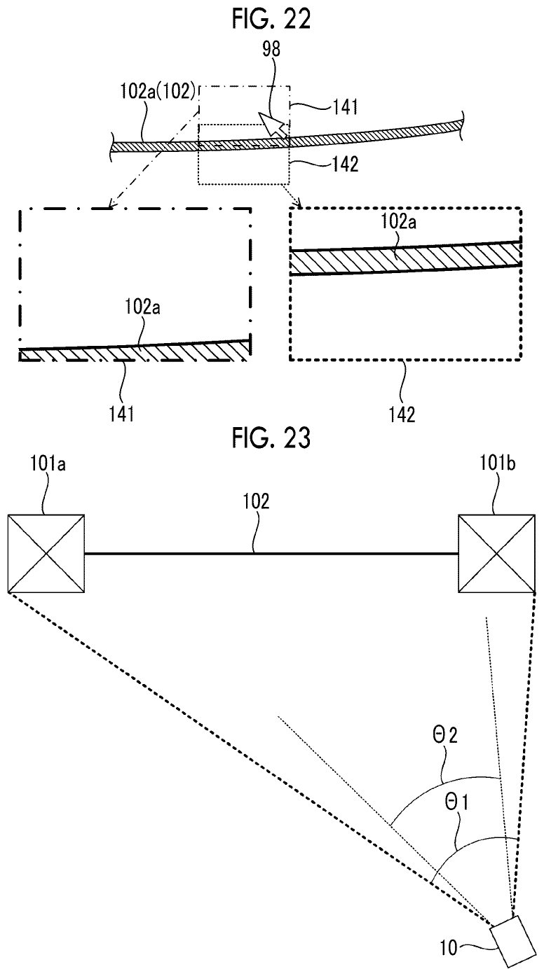

FIG. 22 is a diagram showing an example in which a subject close to the designated coordinates is included in a plurality of imaging regions rn. In a case where a plurality of imaging regions rn are set for a designated imaging target region and the subject (electric wire 102a) is included in two or more imaging regions rn, as shown in FIG. 22, in a case where a composite image is generated, the subject (electric wire 102a) may be included in an overlapping region constituting the composite image, for example, the minified image 141 and the minified image 142. In the case of the present example, in comparison of the electric wire 102a included in the minified image 141 and the electric wire 102a included in the minified image 142, the electric wire 102a included in the minified image 142 is included without any part of the electric wire 102a being missing, whereas the electric wire 102a is included in the minified image 141 in a state where a part (lower side in the drawing) of the electric wire 102a is missing. That is, the occupied area of the electric wire 102a in the minified image 142 is larger than the occupied area of the electric wire 102a in the minified image 141. In such a case, in a case where the coordinates on the minified image 141 in the composite image are designated by the mouse cursor 98, for example, as shown in FIG. 22, the captured image data of the imaging region rn corresponding to the minified image 142 having the largest occupied area of the electric wire 102a in the minified image is searched for instead of the captured image data of the imaging region rn corresponding to the minified image 141.

### <Case of Imaging Target Exceeding Angle of View of Wide Angle End of Camera 10>

FIG. 23 is a diagram showing an example of imaging in a case where an imaging target of the camera 10 exceeds an imaging range of a wide angle end of the camera 10. As shown in FIG. 23, in the inspection work of the present example, the range to be inspected is a range θ1 between the transmission towers 101a and 101b to which the electric wires 102 are connected. On the other hand, the imaging available range of the camera 10 in a case where the camera 10 is set to the wide angle end is the angle of view θ2, which is narrower than the range θ1 to be inspected. Therefore, in such a case, a pseudo wide angle image is generated by panoramic imaging at the wide angle end of the camera 10 so that the entire range of the target to be inspected can be included.

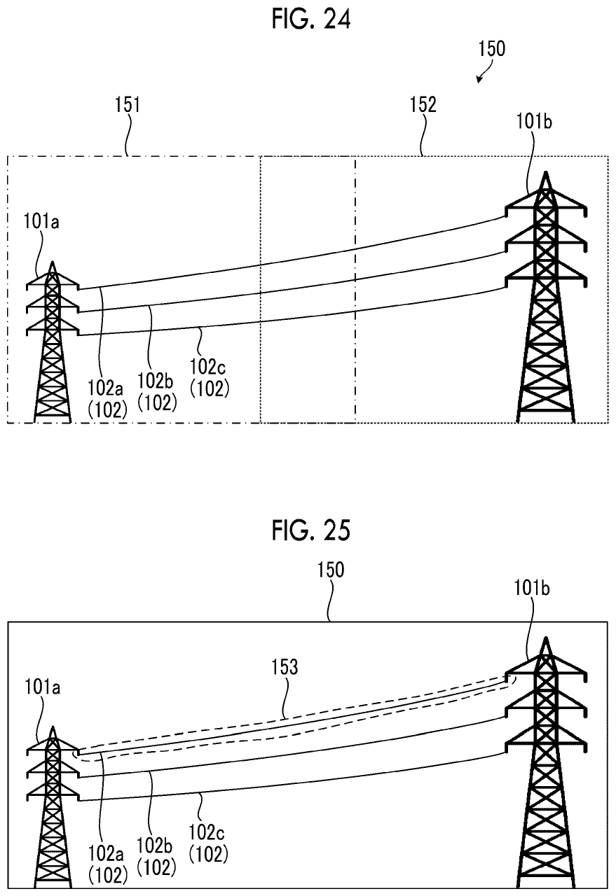

FIG. 24 is a diagram showing an example of a pseudo wide angle image captured by the camera 10. As shown in FIG. 24, the pseudo wide angle image 150 is a wide angle image generated by arranging the wide angle image 151 and the wide angle image 152 captured by the camera 10 so that a part of regions overlap each other in the lateral direction. The wide angle image 151 is an image obtained by imaging a left region in a range of a target to be inspected. The wide angle image 152 is an image obtained by imaging a right region on a side opposite to the wide angle image 151 in a range of a target to be inspected.

FIG. 25 is a diagram illustrating designation of an imaging target region in the pseudo wide angle image 150 generated as described in FIG. 24. As shown in FIG. 25, by designating the imaging target region 153 in a freehand manner to surround the electric wire 102a that is a target to be inspected, the imaging processing of the imaging target region 153 and the combining processing of the composite image are started. In the present example, a case where the imaging is performed with the camera 10 capable of telephoto imaging at the wide angle end has been described. However, for example, the same imaging can be applied even in a case where the target is not included in one image in the imaging with the wide angle camera.

Accordingly, even in a case where the imaging target region of the inspection target is large or the distance to the inspection target is short, it is possible to designate all the regions to be inspected based on one wide angle image displayed on the display 13a, and the time for the inspection work can be shortened.

### <Modification Example of Composite Image 95 Displayed at Time of Designation of Inspection Location>

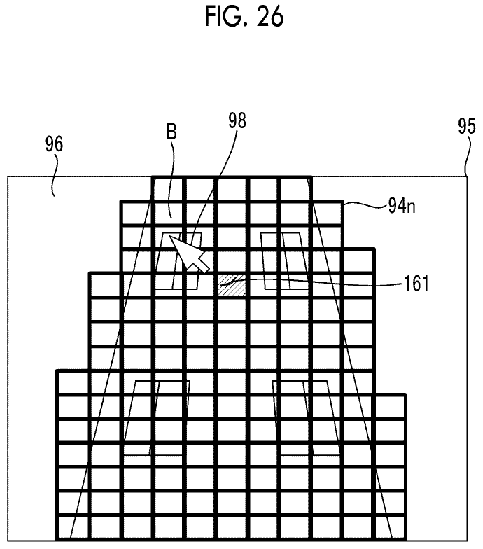

FIG. 26 is a diagram showing a modification example of the composite image 95 displayed on the display 13a in a case of designating the inspection location in the composite image 95 of FIG. 14 described above. As described above, the plurality of minified images 94n constituting the composite image 95 are images generated by performing the resize processing on the plurality of detailed partial images 93n captured by the telephoto imaging in the reduction direction. Therefore, in a case where the detailed partial image 93n is captured, for example, inspection is performed on whether or not there is a scratch or a stain on the target (the wall surface of the building B) captured in the partial image 93n by using image processing by AI. Then, in a case where the scratch or the stain is detected, a mark is added to the minified image 94n corresponding to the detailed partial image 93n in which the scratch or the stain is detected, and the minified image 94n is displayed on the composite image 95. For example, as shown in FIG. 26, in a case where the scratch 161 is detected on the wall surface of the building B by the image processing using AI, the scratch 161 is displayed on the composite image 95 by adding diagonal lines to the minified image 94n corresponding to the detailed partial image 93n in which the scratch 161 is detected. Accordingly, it is possible to easily detect a portion that needs to be checked in the inspection work, and it is possible to shorten the time of the inspection work.

### <Generation of Composite Image by Geometric Processing>

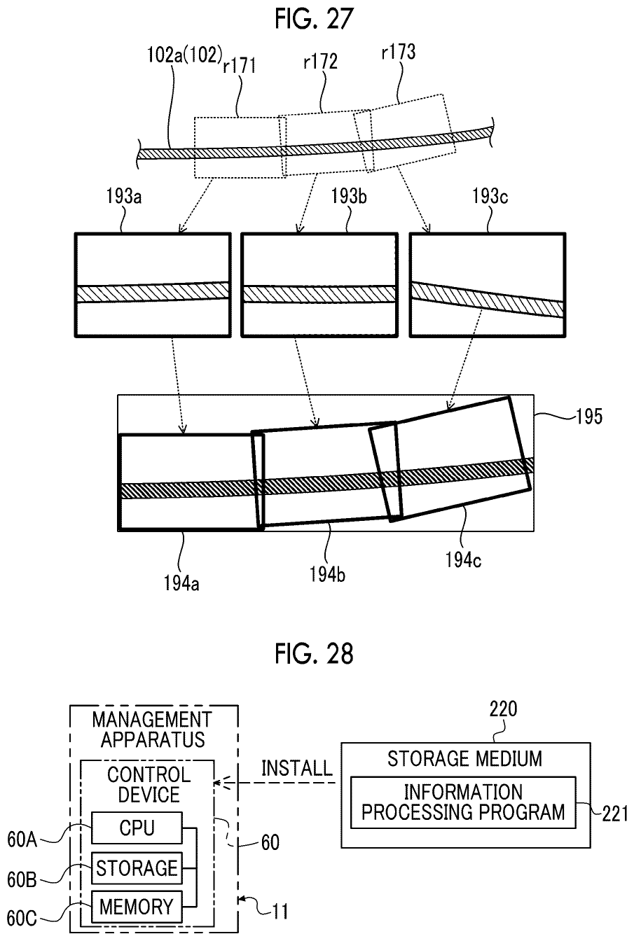

FIG. 27 is a diagram showing an example in which geometric processing is performed in a case where a composite image is generated. As described above with reference to FIG. 15, in a case where the inspection target is the electric wire 102a of the transmission tower 101, the imaging regions rn are arranged in a laterally long shape along the electric wire 102a. Then, in a case where the imaging regions rn are arranged in a laterally long shape, the camera 10 is panned and tilted to acquire the captured image data while performing telephoto imaging on the plurality of imaging regions rn in order.

However, in a case where the plurality of imaging regions rn are imaged by the telephoto imaging while the camera 10 is panned and tilted, for example, as shown in FIG. 27, each of the plurality of imaging regions r171, r172, and r173 is inclined by being rotated by a predetermined angle by the pan/tilt. Therefore, in a case where the detailed partial images 193a, 193b, and 193c obtained by imaging the imaging regions r171, r172, and r173 are arranged in the lateral direction, the images include the electric wires 102a included in the respective images are inclined by a predetermined angle. Therefore, in a case in which the composite image is generated based on the detailed partial images 193a, 193b, and 193c, only performing the resize processing in the simple reduction direction and the combining processing causes a level difference between the electric wires 102a of each minified image constituting the composite image by a rotation of a predetermined angle.

Therefore, in order to eliminate the level difference generated in a case where the composite image is generated, the detailed partial images 193a, 193b, and 193c are subjected to the geometric processing different from the reduction processing and the enlargement processing. The rotation amount (inclination) of the predetermined angle generated by performing telephoto imaging while panning and tilting the camera 10 is a rotation amount that can be calculated from the angle of view and the pan/tilt value, which are the imaging conditions of the camera 10. Therefore, in a case of generating the composite image 195 from the minified images 194a, 194b, and 194c of the detailed partial images 193a, 193b, and 193c, the minified images 194a, 194b, and 194c are each rotated (corrected) by a predetermined angle based on the rotation amount calculated from the imaging conditions so that the level difference is not generated in the electric wire 102a of the composite image 195. As a result, it is possible to correct the distortion that may occur in a case where the composite image 195 is generated, and it is possible to display the composite image 195 which is conspicuous on the management apparatus 11.

The order of each processing in a case of generating the composite image 195 may be, for example, in the order of geometric processing of rotating the detailed partial images 193a, 193b, and 193c, reduction processing of reducing the detailed partial images 193a, 193b, and 193c subjected to the geometric processing, and combining processing of combining the minified images 194a, 194b, and 194c subjected to the reduction processing.

### <Storage Medium of Information Processing Program>

In each of the management controls described above, the example has been described in which the information processing program of each embodiment is stored in the storage 60B of the management apparatus 11 and the CPU 60A of the management apparatus 11 executes the information processing program in the memory 60C; however the technique of the present disclosure is not limited to this.

FIG. 28 is a diagram showing an example of an aspect in which the information processing program for an management control is installed in the control device 60 of the management apparatus 11 from a storage medium in which the information processing program is stored. As shown in FIG. 28 as an example, an information processing program 221 may be stored in a storage medium 220 which is a non-transitory storage medium. In a case of the example shown in FIG. 28, the information processing program 221 stored in the storage medium 220 is installed in the control device 60, and the CPU 60A executes each of the above-described processing according to the information processing program 221.

### <Inspection Image Displayed on Management Apparatus 11>

In the above-described embodiment, in a case of inspecting the captured target image, an example in which the composite image 95 composed of the plurality of minified images 94n is displayed as the entire image displayed on the management apparatus 11 has been described. However, the technique of the present disclosure is not limited thereto. For example, a wide angle image (for example, the wide angle image 91 in FIG. 7) captured by setting the camera 10 to the wide angle end may be displayed as the entire image.

Although various embodiments have been described above, it goes without saying that the present invention is not limited to these examples. It is apparent that those skilled in the art may perceive various modification examples or correction examples within the scope disclosed in the claims, and those examples are also understood as falling within the technical scope of the present invention. In addition, each constituent in the embodiment may be used in any combination without departing from the gist of the invention.

The present application is based on Japanese Patent Application (JP2022-102804) filed on Jun. 27, 2022, the content of which is incorporated in the present application by reference.

### EXPLANATION OF REFERENCES

1: imaging system

10: camera

11: management apparatus

13a: display

16: revolution mechanism

35, 60C: memory

37, 60A: CPU

60: control device

71: yaw-axis revolution mechanism

72: pitch-axis revolution mechanism

91: wide angle image

92 (92a, 92b): imaging target region

93n (93a to 93c, 193a to 193c): detailed partial image

94n (94a to 94c), 141, 142, 194a to 194c: minified image

95, 195: composite image

96: background region

97: coordinate correspondence information

98: mouse cursor

102 (102a to 102c): electric wire

111: windmill

112: blade

121, 122, 123: imaging target point

131: imaging target line

150: pseudo wide angle image

rn (r1, r2, r3, r121 to r125, r171 to r173): imaging region

What is claimed is:

1. An information processing apparatus comprising:
a processor;
wherein the processor is configured to
determine an imaging method for imaging a designated imaging target region a plurality of times according to a form of the imaging target region, in which the imaging method includes acquiring an imaging angle of view and an imaging position in the imaging,
acquire a plurality of pieces of first image data obtained by imaging in the imaging method, and
generate second image data related to the imaging target region by performing, onto the plurality of pieces of first image data, resize processing in a reduction direction and combining processing.

2. The information processing apparatus according to claim 1,
wherein the processor is configured to receive designation for a form other than a rectangular form as the form of the imaging target region.

3. The information processing apparatus according to claim 2,
wherein the processor is configured to, in a case where the designation for the form other than the rectangular form is received as the form of the imaging target region, generate the second image data representing a rectangular image.

4. The information processing apparatus according to claim 1,
wherein the processor is configured to generate first correspondence information that associates a relationship between a first image represented by the first image data and a position of the first image in a second image represented by the second image data.

5. The information processing apparatus according to claim 4,
wherein the processor is configured to perform, based on the first correspondence information, control to display, on a display device, the first image represented by the first image data corresponding to designated coordinates in the second image data.

6. The information processing apparatus according to claim 1,
wherein the resize processing is resize processing including a geometric change.

7. The information processing apparatus according to claim 6,
wherein the resize processing including the geometric change is processing of generating the second image data by the resize processing in the reduction direction, geometric processing of giving a geometric change different from reduction and enlargement to the first image data, and the combining processing, based on the first image data.

8. The information processing apparatus according to claim 7,
wherein the processor is configured to perform processing in an order of the geometric processing, the resize processing in the reduction direction, and the combining processing.

9. The information processing apparatus according to claim 7,
wherein the geometric processing includes rotation processing.

10. The information processing apparatus according to claim 9,
wherein the rotation processing includes processing based on an imaging condition under which the first image data is obtained.

11. The information processing apparatus according to claim 9,
wherein the rotation processing includes processing of calculating a parameter for correcting an inclination of an angle of view during telephoto imaging.

12. The information processing apparatus according to claim 1,
wherein the processor is configured to
control a revolution mechanism that causes an imaging apparatus performing the imaging to revolve, and
generate second correspondence information in which the first image data and a control value of the revolution mechanism at a time of imaging at which the first image data is obtained are associated with each other.

13. The information processing apparatus according to claim 12,
wherein the processor is configured to output a control value corresponding to designated first image data among the plurality of pieces of first image data based on the second correspondence information.

14. The information processing apparatus according to claim 12,
wherein the processor is configured to extract the first image data based on a degree of approximation of a designated control value from among the plurality of pieces of first image data based on the second correspondence information.

15. An information processing method executed by an information processing apparatus, the method comprising:
via a processor of the information processing apparatus,
determining an imaging method for imaging a designated imaging target region a plurality of times according to a form of the imaging target region, in which the imaging method includes acquiring an imaging angle of view and an imaging position in the imaging;
acquiring a plurality of pieces of first image data obtained by imaging in the imaging method; and
generating second image data related to the imaging target region by performing, onto the plurality of pieces of first image data, resize processing in a reduction direction and combining processing.

16. A non-transitory computer readable medium storing an information processing program for an information processing apparatus, the program causing a processor of the information processing apparatus to execute a process comprising:
determining an imaging method for imaging a designated imaging target region a plurality of times according to a designated form of the imaging target region, in which the imaging method includes acquiring an imaging angle of view and an imaging position in the imaging;
acquiring a plurality of pieces of first image data obtained by imaging in the imaging method; and
generating second image data related to the imaging target region by performing, onto the plurality of pieces of first image data, resize processing in a reduction direction and combining processing.

17. An information processing apparatus comprising:
a processor;
wherein the processor is configured to
determine an imaging method for imaging a designated imaging target region a plurality of times according to a form of the imaging target region,
acquire a plurality of pieces of first image data obtained by imaging in the imaging method,
generate second image data related to the imaging target region by performing, onto the plurality of pieces of first image data, resize processing in a reduction direction and combining processing, and
acquire a reduction rate in the resize processing in the reduction direction based on a size of a second image represented by the second image data.

18. An information processing method executed by an information processing apparatus, the method comprising:
via a processor of the information processing apparatus,
determining an imaging method for imaging a designated imaging target region a plurality of times according to a form of the imaging target region;
acquiring a plurality of pieces of first image data obtained by imaging in the imaging method;
generating second image data related to the imaging target region by performing, onto the plurality of pieces of first image data, resize processing in a reduction direction and combining processing; and
acquiring a reduction rate in the resize processing in the reduction direction based on a size of a second image represented by the second image data.

19. A non-transitory computer readable medium storing an information processing program for an information processing apparatus, the program causing a processor of the information processing apparatus to execute a process comprising:
determining an imaging method for imaging a designated imaging target region a plurality of times according to a designated form of the imaging target region;
acquiring a plurality of pieces of first image data obtained by imaging in the imaging method;
generating second image data related to the imaging target region by performing, onto the plurality of pieces of first image data, resize processing in a reduction direction and combining processing; and
acquiring a reduction rate in the resize processing in the reduction direction based on a size of a second image represented by the second image data.

20. An information processing apparatus comprising:
a processor;
wherein the processor is configured to
determine an imaging method for imaging a designated imaging target region a plurality of times according to a form of the imaging target region,
acquire a plurality of pieces of first image data obtained by imaging in the imaging method,
generate second image data related to the imaging target region by performing, onto the plurality of pieces of first image data, resize processing in a reduction direction and combining processing, and
after acquiring distance measurement information of a plurality of positions in the imaging target region with a smaller number of times of imaging than the number of times of imaging in the imaging method, perform control of causing the imaging apparatus to execute the imaging by means of the imaging method based on the distance measurement information.

21. An information processing method executed by an information processing apparatus, the method comprising:
via a processor of the information processing apparatus,
determining an imaging method for imaging a designated imaging target region a plurality of times according to a form of the imaging target region;
acquiring a plurality of pieces of first image data obtained by imaging in the imaging method;
generating second image data related to the imaging target region by performing, onto the plurality of pieces of first image data, resize processing in a reduction direction and combining processing; and
after acquiring distance measurement information of a plurality of positions in the imaging target region with a smaller number of times of imaging than the number of times of imaging in the imaging method, performing control of causing the imaging apparatus to execute the imaging by means of the imaging method based on the distance measurement information.

22. A non-transitory computer readable medium storing an information processing program for an information processing apparatus, the program causing a processor of the information processing apparatus to execute a process comprising:
determining an imaging method for imaging a designated imaging target region a plurality of times according to a designated form of the imaging target region;
acquiring a plurality of pieces of first image data obtained by imaging in the imaging method;
generating second image data related to the imaging target region by performing, onto the plurality of pieces of first image data, resize processing in a reduction direction and combining processing in a reduction direction; and
after acquiring distance measurement information of a plurality of positions in the imaging target region with a smaller number of times of imaging than the number of times of imaging in the imaging method, performing control of causing the imaging apparatus to execute the imaging by means of the imaging method based on the distance measurement information.
